(19) United States
(12) Patent Application Publication
(10) Pub. No.: US 2026/0289138 A1
(43) Pub. Date: Sep. 24, 2026

(54) SYSTEM

(71) Applicant: SoftBank Group Corp., Tokyo (JP)

(72) Inventor: Shiho ONO, Tokyo (JP)

(73) Assignee: SoftBank Group Corp., Tokyo (JP)

(21) Appl. No.: 19/567,346

(22) Filed: Mar. 16, 2026

(30) Foreign Application Priority Data
Mar. 19, 2025 (JP) 2025-045129

(51) Int. Cl. G06F 40/30; G06F 40/186; G06F 40/284; G06F 40/295; G06N 3/0475; G10L 15/26; G10L 25/63

(52) U.S. Cl. CPC G06F 40/30; G06F 40/186; G06F 40/284; G06F 40/295; G10L 15/26; G10L 25/63; G06N 3/0475

(57) ABSTRACT

A system includes a processor that is configured to acquire a voice of a user, analyze a voice signal corresponding to the voice of the user by using a speech recognition technique, and convert a result of the analysis into character information, acquire the character information and state information of the user from a database, and combine the character information and the state information of the user to identify an issue of the user, and generate a prompt for instructing a generative artificial intelligence model to generate a solution for the identified issue, input the prompt into the generative artificial intelligence model to cause the generative artificial intelligence model to generate the solution, and provide the generated solution to the user.

### CROSS-REFERENCE TO RELATED APPLICATION

This application is based on and claims priority under 35 USC 119 from Japanese Patent Application No. 2025-045129 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional customer support and problem-solving systems require human operators to manually interpret user utterances, understand the user's context from separate databases, and formulate appropriate responses. This manual process leads to significant delays in response time, increased labor costs, and inconsistent quality of support. In particular, when the user communicates verbally, additional time and effort are required to transcribe, interpret, and correlate the spoken content with user state information, such as purchase history, browsing history, and inquiry history. Furthermore, existing systems do not adequately utilize emotional information contained in the user's voice to adjust the tone or content of the response, which may result in reduced user satisfaction. Therefore, there is a need for a system that can automatically acquire and analyze a user's voice, combine the resulting character information with user state information, and autonomously generate and provide an appropriate solution by using a generative artificial intelligence model, thereby improving response speed, reducing interpretation cost, and enhancing the relevance and tone of the solution.

### SUMMARY

In order to solve the above-described problems, the present invention provides a system comprising a processor, wherein the processor is configured to acquire a voice of a user, analyze a voice signal corresponding to the voice of the user by using a speech recognition technique, and convert a result of the analysis into character information. The processor is further configured to acquire the character information and state information of the user from a database, and to combine the character information and the state information of the user to identify an issue of the user. The processor is further configured to generate a prompt for instructing a generative artificial intelligence model to generate a solution for the identified issue, to input the prompt into the generative artificial intelligence model to cause the generative artificial intelligence model to generate the solution, and to provide the generated solution to the user. In some embodiments, the processor is configured to analyze an emotion of the user from the voice of the user by using an emotion analysis technique, and to reflect a result of the emotion analysis in the prompt input to the generative artificial intelligence model, thereby adjusting the content and tone of the generated solution according to the user's emotional state. In some embodiments, the processor is configured to transmit the generated solution to a terminal of the user and provide the generated solution to the user through the terminal, thereby enabling rapid and context-aware responses without requiring manual intervention by human operators.

The term “processor” refers to one or more hardware processing units or circuits, such as a central processing unit (CPU), a graphics processing unit (GPU), a digital signal processor (DSP), or a combination thereof, that execute instructions to perform the functions described in the present specification and claims.

The term “voice of a user” refers to an acoustic signal produced by the user and captured as an audio signal by an input device, such as a microphone, including spoken language, utterances, or other vocal sounds used for communication.

The term “voice signal” refers to an electrical or digital representation of the voice of a user, which is obtained by converting the acoustic signal into an analog or digital form suitable for processing by the processor or an external service.

The term “speech recognition technique” refers to a technique, algorithm, or service that processes a voice signal to detect and recognize linguistic content and outputs a corresponding textual representation, including but not limited to automatic speech recognition systems and cloud-based speech-to-text services.

The term “character information” refers to textual data obtained by converting the voice signal into a sequence of characters, words, or sentences, and representing the linguistic content of the user's utterance in a machine-readable text format.

The term “state information of the user” refers to information indicating a status, context, or history associated with the user, including but not limited to purchase history, browsing history, usage history, inquiry history, account information, or preference information, which is stored in a database and used to interpret the user's issue.

The term “database” refers to a data storage system, which may be implemented as a relational database, a non-relational database, or any other structured or semi-structured data storage, that stores the character information, the state information of the user, or related records for retrieval and processing by the processor.

The term “issue of the user” refers to a problem, request, question, complaint, or other matter to be addressed on behalf of the user, which is identified by analyzing the character information and the state information of the user.

The term “generative artificial intelligence model” refers to a machine learning model, such as a large language model or other generative model, that is configured to generate text, instructions, or other output content based on input data including prompts, and that can produce a solution for the user's issue.

The term “prompt” refers to an input text or structured input data provided to the generative artificial intelligence model, the input text or structured input data specifying at least the identified issue of the user and optionally additional context, constraints, or instructions to guide generation of the solution.

The term “solution” refers to output content generated by the generative artificial intelligence model in response to the prompt, the output content including at least an answer, guidance, procedure, or recommendation intended to address or resolve the identified issue of the user.

The term “emotion analysis technique” refers to a technique, algorithm, or model that analyzes the voice of the user or a corresponding voice signal to estimate an emotional state of the user, such as anger, frustration, satisfaction, or calmness, and outputs an emotion analysis result usable to adapt the generated solution.

The term “emotion analysis result” refers to data representing an estimated emotional state of the user, which may include an emotion label, an intensity value, or a probability distribution over multiple emotions, and which is reflected in the prompt or otherwise used to adjust the generated solution.

The term “terminal of the user” refers to an electronic device operated by the user, such as a smartphone, tablet, personal computer, smart speaker, or other client device, that is configured to receive the generated solution from the system and present the generated solution to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

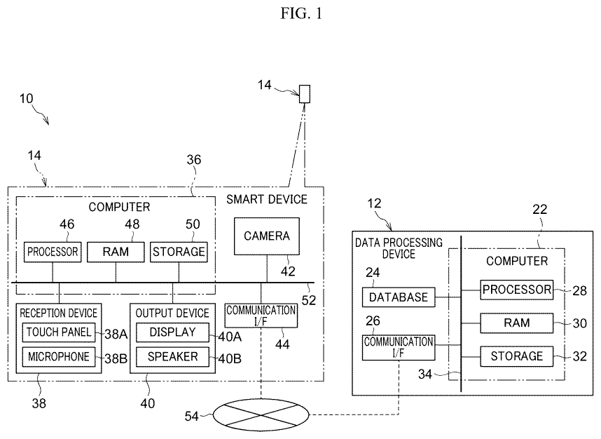

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

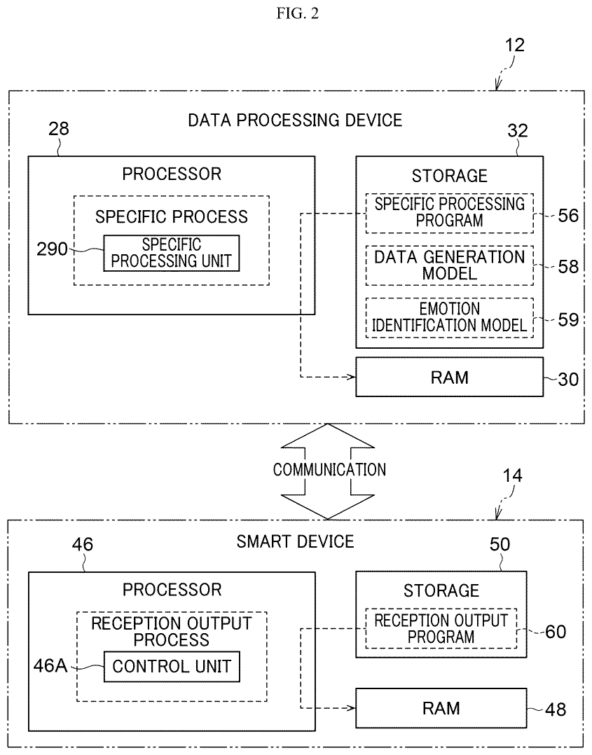

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional voice-based support systems typically convert user speech to text and then apply fixed, rule-based logic to search for predefined responses or knowledge items. Such systems suffer from several technical limitations. First, they are not designed to dynamically combine recognized text with rich user history information in a structured manner, and therefore cannot accurately identify which past transaction, configuration, or interaction is most relevant to the current utterance. Second, even when generative AI models are employed, conventional systems often pass only the raw transcribed text as input, without performing systematic extraction of intent and target information or without constructing a contextually optimized prompt sentence that expresses the user's task in a machine-interpretable way. This leads to suboptimal use of computational resources, inconsistent output quality, and an increased need for downstream filtering or manual intervention.

Moreover, existing architectures typically treat speech recognition, user history retrieval, and generative AI invocation as loosely coupled modules, without a processor-controlled workflow that integrates these components into a coherent data-processing pipeline. As a result, such systems exhibit increased latency, redundant network calls, and repeated database queries, which degrade the responsiveness of the computer system and reduce throughput on server infrastructure. In addition, the absence of a standardized, template-based prompt generation mechanism prevents effective reuse of computation and complicates maintenance and tuning of prompts for different task types, thereby limiting scalability and robustness.

Accordingly, there is a need for an improved computer-implemented system that: (i) efficiently converts user voice input into character information, (ii) programmatically correlates that character information with user history information stored in an information storage device, (iii) automatically extracts specific information such as task type, intent, and target from the combined data, and (iv) generates a structured prompt sentence for a generative AI model in a way that consistently improves response accuracy, reduces computational waste, and enhances overall system performance.

The specific processing by the specific processing unit 290 of the data processing device 12 in Example 1 is realized by the following means.

The present invention provides a server comprising a processor configured to receive voice data of a user from a terminal, analyze the received voice data by using a speech recognition process including an acoustic model and a language model to generate character information, acquire history information related to the user from an information storage device based on user identification information, combine and analyze the character information and the history information to extract specific information relating to a task of the user, construct a prompt sentence for input to a generative AI model based on the specific information and the history information, the prompt sentence including a type of the task and related target information, input the prompt sentence to the generative AI model to cause the generative AI model to execute a text generation process and generate solution information for the task, and format and transmit the solution information to the terminal for presentation to the user. This enables the server to implement an integrated, processor-controlled pipeline that more efficiently transforms raw voice input and stored history information into optimized prompt sentences for a generative AI model, thereby improving accuracy and consistency of generated solutions, reducing redundant computation and data access, and enhancing the technical performance and responsiveness of the computer system.

The term “voice data” refers to digital audio information representing speech uttered by a user and captured by an input device, such as a microphone of a terminal.

The term “terminal” refers to an information processing apparatus operated by a user, including at least an input device, a display device, and a communication function, and configured to transmit voice data and receive solution information.

The term “processor” refers to a hardware computation element, such as a central processing unit or an execution core, configured to execute program instructions to perform the functions described for the system.

The term “speech recognition process” refers to a series of computational operations that convert voice data into character information by using models such as an acoustic model and a language model.

The term “acoustic model” refers to a data structure and associated algorithms used in speech recognition to represent a relationship between audio features of voice data and basic sound units.

The term “language model” refers to a data structure and associated algorithms used in speech recognition to represent probabilities of sequences of linguistic units, such as words or characters, for improving recognition accuracy.

The term “character information” refers to text data obtained as a recognition result of voice data, representing the content of a user's utterance in a symbolic form.

The term “user identification information” refers to data that uniquely or quasi-uniquely associates a request with a user, such as an identifier, token, or account reference, used to retrieve history information.

The term “information storage device” refers to a data storage component, such as a database system or memory subsystem, configured to store and provide history information and other data used by the processor.

The term “history information” refers to data representing past states, actions, or interactions related to a user, including but not limited to transaction records, configuration records, inquiry logs, and usage logs.

The term “task of the user” refers to a problem, request, or objective expressed by the user, for which the system is intended to generate solution information.

The term “specific information” refers to structured data derived from analysis of character information and history information, including at least one of a task type, an intent, and a target object relevant to the user's task.

The term “intent information” refers to data indicating a purpose or category of the user's request, such as a request for instructions, troubleshooting, or explanation.

The term “target information” refers to data specifying an object to which the user's task relates, such as a product, service, configuration, or record identified from the character information and history information.

The term “generative AI model” refers to a machine learning model configured to generate text by probabilistically predicting sequences of linguistic units based on an input prompt sentence.

The term “prompt sentence” refers to text data provided as input to the generative AI model, the text data including at least one of character information, history information, specific information, a task type, and target information, and instructing the generative AI model regarding a generation task.

The term “solution information” refers to text data generated by the generative AI model as a response to the prompt sentence, the text data including at least one of an explanation, a guide, or a proposed action for addressing the user's task.

The term “template” refers to a predefined text structure including placeholders, the placeholders being configured to receive character information, history information, or specific information to form a prompt sentence.

The term “type of the task” refers to a classification of a user's task into one of a plurality of categories, such as instruction assistance, troubleshooting, or information explanation, used to select a template or generation policy.

The term “display format” refers to a structured representation of solution information adapted for presentation on a terminal, including at least one of paragraph division, list formatting, or emphasis markers.

In one or more embodiments, a server cooperates with at least one terminal operated by a user to implement a voice-based assistance system that generates solutions to user tasks by using a generative AI model. The server includes a processor, a memory, a network interface, and access to an information storage device such as a relational database system. The terminal includes at least a microphone, a display, a local processor, and a communication interface.

The server executes software components implemented, for example, on an operating system such as a general-purpose server operating system, and an application framework such as a web application framework. The server runs modules including a speech recognition client module, a natural language processing module, a history correlation module, a prompt construction module, a generative AI client module, and a response formatting module. The server stores data structures such as user records, history records, prompt templates, and logs in the information storage device.

The terminal executes an application program that uses an operating system API, for example an audio recording API, to acquire analog speech from the user through the microphone and convert the analog signal into digital voice data. The terminal compresses or encodes the digital voice data, attaches metadata such as a user identifier and a language identifier, and transmits the voice data to the server via a network protocol such as HTTPS. The terminal also receives solution information from the server and displays the information on a graphical user interface.

The server uses a speech recognition process to convert the received voice data into character information. In one embodiment, the server calls an external speech recognition service through an API, where the service uses an acoustic model and a language model implemented by a neural network architecture. In another embodiment, the server runs a speech recognition engine locally. The acoustic model can be implemented as a deep neural network, for example a convolutional neural network or a recurrent neural network, that receives feature vectors such as Mel-frequency cepstral coefficients extracted from the waveform and outputs probability distributions over phonetic units. The language model can be implemented as a statistical model or a neural language model, for example a recurrent network or a transformer-based model, that assigns probabilities to word sequences and guides decoding. The server performs decoding using an algorithm such as beam search to determine a most probable sequence of textual units, and stores the resulting character information in memory.

The server acquires history information related to the user from the information storage device. The server identifies the user based on user identification information contained in the request from the terminal. The server retrieves records such as transaction records, configuration records, and previous query logs by executing queries against a database management system. The server represents the history information in structured data objects, each object including attributes such as an item identifier, a category identifier, a timestamp, and a status. The server may index the history information in auxiliary data structures, for example inverted indices or hash maps keyed by item category, to accelerate correlation with character information.

The server uses a natural language processing module to analyze the character information. The server normalizes the text, performs tokenization, and converts tokens into numerical representations such as embeddings. In one embodiment, the server employs a transformer-based encoder model trained for intent classification and entity extraction. The encoder receives token embeddings, processes them through multiple self-attention layers and feed-forward layers, and outputs contextualized representations for each token and a pooled representation for the entire sequence. The server applies a classification layer to the pooled representation to determine a task type, such as instruction assistance or troubleshooting, and applies sequence labeling layers to the token-level representations to identify target entities such as product categories or configuration parameters.

The server correlates the extracted intent information and target information with the history information. The server may compute similarity scores between embedding vectors of entities extracted from the character information and embedding vectors of items stored in the history information. The server may use a distance measure such as cosine similarity or Euclidean distance and may introduce weighting factors to favor recent records by including time-based decay factors in the similarity computation. The server selects a history item that maximizes a relevance score computed from the similarity score and additional criteria such as recency or usage frequency. The server thus generates specific information including at least a type of the task, a target object, and context attributes derived from the history information.

The server constructs a prompt sentence for input to a generative AI model. The server stores multiple prompt templates in a template store, each template corresponding to a particular task type. Each template is a text pattern that includes placeholders for character information, history information, and specific information. The server selects an appropriate template based on the task type in the specific information. The server replaces the placeholders with concrete values, for example the user's original utterance text, a target object name, and relevant history attributes such as a purchase date or configuration state. The server may also insert system-level instructions into the prompt sentence to constrain style, level of detail, and output structure.

In one example, the user asks about how to use a recently acquired item. The user utters a sentence such as “Please tell me how to use the product I bought recently.” The terminal captures and transmits the voice data. The server converts the voice data to character information corresponding to that sentence, retrieves a most recent purchase record from the history information, and determines that the target object is a specific device. The server constructs a prompt sentence such as:
“The user said: ‘Please tell me how to use the product I bought recently.’ The user's most recent purchase is a smart device purchased on 2026-01-25. Act as a support expert and provide a clear, step-by-step usage guide for this smart device suitable for a non-expert user, including initial setup and basic daily operations.”

In another example, the user encounters a connectivity issue. The user says “I am having trouble connecting my new router to the internet.” The server retrieves history information indicating a recent acquisition of a network device and identifies this device as the target object. The server constructs a prompt sentence such as:
“The user said: ‘I am having trouble connecting my new router to the internet.’ The user's history shows a recent purchase of a network device. Identify common causes of connection failure for such a device and generate a step-by-step troubleshooting guide that the user can perform without advanced technical knowledge.”

The server transmits the constructed prompt sentence to a generative AI model. In one embodiment, the generative AI model is a large-scale transformer-based language model executing on specialized hardware such as a graphics processing unit or a tensor processing accelerator. The generative AI model includes an embedding layer, a plurality of transformer blocks with multi-head self-attention mechanisms and position-wise feed-forward layers, and an output projection layer followed by a softmax function. The model processes tokenized prompt sentences, computes attention weights across token positions, and generates probability distributions for successive output tokens. The server controls model parameters such as a sampling temperature, a maximum number of output tokens, and a decoding strategy such as top-k sampling or nucleus sampling to trade off between determinism and diversity.

The server obtains solution information from the generative AI model as a sequence of generated tokens that are converted back to text. The server performs post-processing operations on the solution information, such as inserting line breaks between logical steps, adding ordinal indicators to step descriptions, or converting detected warning phrases into highlighted segments for display. The server may enforce constraints by truncating outputs longer than a predetermined threshold or by filtering tokens using a list of prohibited terms. The server formats the solution information according to a display format that is adapted to the terminal. For example, the server may embed the solution information into a structured response object that includes fields for headings, paragraphs, and lists. The server transmits the formatted solution information to the terminal over the network. The terminal receives the response, parses the structured data, and renders the solution information on a graphical user interface. The terminal may present the steps as a scrollable list, and may allow the user to request additional details, in which case the server can use the previous prompt sentence and solution information as context for building a new prompt sentence.

The server improves computer technology by integrating speech recognition, history correlation, and generative text generation into a single, processor-controlled pipeline that reduces redundant data transfer and processing. Because the server constructs a prompt sentence that explicitly encodes task type and target information, the generative AI model receives a more constrained and context-rich input. This reduces the number of tokens required for generation, thereby lowering compute time and memory usage inside the generative AI model. As a result, the server can handle more concurrent requests on the same hardware resources, improving throughput.

The server also improves accuracy by employing structured correlation between character information and history information. By using numerical embeddings and similarity metrics instead of only keyword matching, the server can robustly identify relevant history records even when the user's utterance uses synonyms or paraphrases. This reduces misalignment between user intent and target object, which in turn decreases the rate of irrelevant or incorrect responses generated by the generative AI model. The reduction in error rates leads to fewer repeated requests and less network traffic and database access, yielding an overall improvement in system efficiency.

In addition, the server uses a non-conventional, template-based prompt construction mechanism that is specifically optimized for the generative AI model. Rather than simply passing the full transcribed text to the model, the server selects templates conditioned on task type and inserts structured data derived from history correlation. This template mechanism imposes a consistent structure on prompts, which allows the generative AI model to converge on stable output patterns that are easier to parse and present. Because the prompt sentence is encoded with well-defined segments, such as a user utterance section, a history context section, and an instruction section, the model can allocate attention more effectively across the sequence, improving both speed and quality of generation.

The server can use multiple generative AI models or multiple configurations of a single model. For example, the server may employ a smaller model for short, low-complexity tasks and a larger model for complex, multi-step tasks. The server can inspect the specific information and select an appropriate model or setting, thereby further optimizing computational load. The server can also cache associations between specific information and solution information, so that repeated tasks with similar patterns can be served from cache without re-invoking the generative AI model, which reduces compute and latency.

The generative AI model is trained in advance using a training set of text pairs. During training, the model updates its parameters using a loss function such as cross-entropy between predicted token distributions and ground-truth tokens. The model uses backpropagation to compute gradients and updates weight matrices in the transformer blocks using an optimization algorithm such as stochastic gradient descent with momentum or an adaptive method. The training may include data augmentation procedures such as paraphrasing or injection of synthetic noise to improve robustness. The server, when deployed, uses the trained parameters and does not re-train the model in response to individual requests; however, the server may log anonymized prompt sentences and solution information pairs for offline fine-tuning or evaluation.

The server, in one embodiment, implements the natural language processing module and the history correlation module as distinct software components communicating over internal interfaces. In another embodiment, the server integrates these functions into a single module that performs joint intent detection and target selection. The server may store intermediate representations such as embeddings and specific information in memory so that subsequent processing stages can avoid recomputing them, thereby improving performance.

The system is not limited to a particular domain of user tasks. The server can adapt the same architecture to technical support for devices, configuration assistance for software systems, explanation of complex data records, or other contexts where voice-based input, historical context, and generative text output are beneficial. The technical contribution of the system resides in the combined data structures, processing pipeline, and generative AI integration that together improve the speed, accuracy, and resource efficiency of voice-based assistance on computer hardware, rather than in any particular business or administrative application.

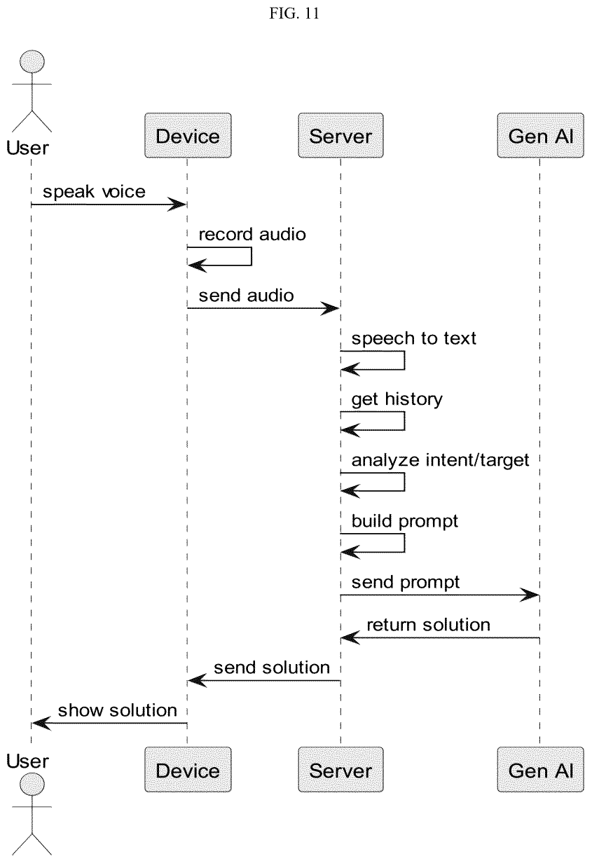

The following describes the processing flow using FIG. 11.

### Step 1

The user provides a voice utterance.

The user speaks a request or problem into a microphone of the terminal, for example, “Please tell me how to use the product I bought recently.”
Input: None (user action).
Output: Analog audio signal representing the user's speech.

### Step 2

The terminal acquires and digitizes the audio signal.
The terminal uses its microphone and an audio API to sample the analog audio signal at a given sampling rate, convert it to digital voice data (for example, 16-bit PCM frames), and temporarily store the frames in a memory buffer or file.
Input: Analog audio signal from the microphone.
Output: Digital voice data (a sequence of audio samples).

### Step 3

The terminal packages and sends the digital voice data to the server.
The terminal compresses or encodes the digital voice data if necessary, attaches metadata such as user identification information and language code, wraps these in a network request, and transmits the request to the server over a secure communication channel.
Input: Digital voice data and local user/session metadata.
Output: Network message containing encoded voice data and metadata.

### Step 4

The server receives and parses the network message.
The server accepts the incoming request via a network interface, validates headers and authentication information, extracts the encoded voice payload and metadata, and stores them in a request context structure in memory for further processing.
Input: Network message from the terminal.
Output: Internal request context including digital voice data and user identification information.

### Step 5

The server performs speech recognition to obtain character information.
The server supplies the digital voice data from the request context to a speech recognition process that applies an acoustic model and a language model to convert the audio samples into text, and then stores the resulting text as character information.
Input: Digital voice data.
Output: Character information representing a transcription of the user's utterance.

### Step 6

The server retrieves history information for the user.
The server uses the user identification information from the request context to query an information storage device, executes database operations to fetch records such as past purchases, configurations, or inquiries, and loads these records into structured objects in memory as history information.
Input: User identification information.
Output: History information consisting of structured records associated with the user.

### Step 7

The server preprocesses the character information.
The server normalizes the character information by performing operations such as lowercasing, tokenization, and removal of extraneous symbols, and generates a sequence of tokens and corresponding numerical representations suitable for subsequent analysis.
Input: Raw character information.
Output: Preprocessed text tokens and associated representations.

### Step 8

The server extracts intent information and target information.
The server applies a natural language processing algorithm to the preprocessed text tokens, calculates classification scores for possible task types, detects candidate entities that may represent target objects, and outputs structured intent information and target information.
Input: Preprocessed text tokens and associated representations.
Output: Intent information (for example, task type) and target information (for example, candidate object names or categories).

### Step 9

The server correlates target information with history information to produce specific information.
The server compares the target information with elements in the history information by computing similarity scores or applying matching rules, selects the most relevant history record, and constructs specific information that includes a determined task type, a selected target object, and contextual attributes from the chosen record.
Input: Intent information, target information, and history information.
Output: Specific information describing the user's task and relevant context.

### Step 10

The server selects an appropriate prompt template.
The server uses the task type within the specific information to choose one template from a set of predefined prompt templates, and loads the selected template into memory for further filling.
Input: Specific information including task type.
Output: Selected prompt template containing placeholders.

### Step 11

The server constructs a prompt sentence for a generative AI model.
The server replaces placeholders in the selected prompt template with values derived from the character information, the history information, and the specific information, assembles these values into coherent text, and generates a complete prompt sentence that describes the user's task and context.
Input: Selected prompt template, character information, history information, and specific information.
Output: Prompt sentence formatted for input to a generative AI model.

### Step 12

The server sends the prompt sentence to the generative AI model and obtains solution information.
The server transmits the prompt sentence to the generative AI model, invokes a text generation process that computes output token probabilities and selects tokens according to predetermined decoding rules, and receives a sequence of tokens that the server converts into solution information as text.
Input: Prompt sentence.
Output: Solution information generated in response to the prompt sentence.

### Step 13

The server post-processes and formats the solution information.
The server analyzes the solution information to identify logical sections, inserts formatting such as line breaks and step markers, applies any filtering rules, and encapsulates the formatted solution in a response structure suitable for transmission to the terminal.
Input: Raw solution information from the generative AI model.
Output: Formatted solution information and associated response structure.

### Step 14

The server returns the formatted solution information to the terminal.
The server serializes the response structure containing the formatted solution information, attaches appropriate headers, and transmits the response over the network to the terminal that initiated the request.
Input: Formatted solution information and response structure.
Output: Network response message containing solution information.

### Step 15

The terminal receives and displays the solution information to the user.
The terminal parses the received response message, extracts the formatted solution information, renders the information in a user interface as text, lists, or other visual elements, and presents the rendered solution so that the user can read and act upon it.
Input: Network response message containing solution information.
Output: Visual display of the solution information presented to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented assistance systems for online shopping and problem solving typically treat speech recognition, user behavior analysis, and content generation as loosely coupled and largely siloed functions. A speech recognition engine merely outputs transcribed text, a recommendation engine relies on coarse statistical profiles or static rules, and a response generator produces generic content that is weakly conditioned, if at all, on the concrete context of an individual user session. As a result, these systems often generate recommendations and solutions that are not sufficiently personalized, not aligned with a user's real-time intent, and not efficiently computable at scale.

From the perspective of computer technology, existing architectures and processing flows suffer from several technical shortcomings. First, there is no unified data structure that tightly integrates transcribed text, fine-grained user state information (such as recent purchase history and browsing history), and session-specific preference inferences into a machine-usable context for downstream processing. This leads to redundant database accesses, fragmented feature computation, and inefficient use of processing resources.

Second, conventional systems do not optimize the construction of inputs to a generative AI model as a structured prompt sentence that encodes both current user intent and historically derived preference attributes in a manner suitable for deterministic processing by downstream components. The absence of a systematic prompt construction mechanism causes inconsistent behavior of the generative AI model, increases the need for ad hoc post-processing, and results in unstable system-level performance.

Third, feedback from user interaction with generated recommendations—such as selection operations on recommended items, non-selection behavior, and repeated refinement queries—is not effectively reintegrated into the core processing pipeline. Without a mechanism for logging and reusing this operational feedback to adjust context generation and prompt generation, the system cannot efficiently improve its future performance, and computing resources are consumed on repeated ineffective suggestion patterns.

Furthermore, while some systems analyze sentiment or emotion, they generally do so as a human-facing feature, not as an internal control signal for a machine learning pipeline. Emotion information is rarely represented as a structured parameter that modulates the expression format, detail level, or tone of generated content in a reproducible way. This underutilization of emotion as a computational control variable reduces the precision and adaptability of system behavior.

Accordingly, there is a need for an improved computer-implemented system and processing method that: (i) unifies speech recognition results, user state information, and inferred preferences into a consistent context representation; (ii) systematically constructs a prompt sentence for a generative AI model based on this context; (iii) post-processes model output into machine-usable identifiers and presentation information; and (iv) uses interaction logs and emotion analysis results as internal control signals. Such a system should improve the efficiency, reliability, and technical performance of the underlying computing platform in generating personalized solutions and item proposals, rather than merely automating a human decision process.

The specific processing by the specific processing unit 290 of the data processing device 12 in Application Example 1 is realized by the following means.

The present invention provides a server comprising a processor configured to acquire voice input of a user, analyze an audio signal from the voice input by using a speech processing function, and convert the audio signal into character information; to obtain user state information from a storage device based on user identification information associated with the character information, and to extract preference information of the user based on purchase history information and browsing history information included in the user state information; to analyze the character information and the preference information to specify an intention of the user and a task of the user, and to generate context information including an intention type, a target item, a budget range, and preference attributes; to generate a prompt sentence including the context information and the character information, and to input the prompt sentence into a generative AI model including a natural language processing function, thereby causing the generative AI model to generate response information including a solution for the task of the user and proposal information of a target item suitable for the user; to extract identification information of a target item from the response information, to obtain attribute information of the target item from a product information storage device based on the identification information, and to generate presentation information by associating explanation information included in the response information with the attribute information; and to transmit the presentation information to a user terminal and to control that the user terminal presents the target item and presents the solution. This enables the computing system to internally construct a unified, machine-usable context from multimodal and historical data, to systematically condition a generative AI model via a structured prompt sentence, to convert generated natural language output into concrete item-level presentation information, and to thereby improve the technical efficiency, consistency, and personalization performance of computer-implemented recommendation and problem-solving processes.

The term “voice input” refers to audio data representing speech uttered by a user and captured by an input device such as a microphone of a terminal or another audio acquisition apparatus.

The term “audio signal” refers to a time-varying electrical or digital signal that encodes the waveform of the voice input and is processable by a speech processing function.

The term “speech processing function” refers to a software-implemented or hardware-implemented function that analyzes an audio signal to perform at least one of speech recognition, feature extraction, or acoustic modeling, and outputs data including character information.

The term “character information” refers to text data obtained by converting an audio signal into a sequence of characters or symbols that represent the content of the speech utterance in a natural language.

The term “user identification information” refers to information including at least one of a user identifier, an account identifier, a session identifier, or device-related identification that allows association of character information with user state information stored in a storage device.

The term “user state information” refers to aggregated information related to behavior or transactions of a user, including at least purchase history information and browsing history information, and optionally additional behavioral or profile information stored in a storage device.

The term “purchase history information” refers to information indicating records of items previously acquired by a user, including at least item identifiers, transaction times, and optionally quantities, prices, or item attributes.

The term “browsing history information” refers to information indicating records of items or content that have been displayed or accessed by a user, including at least item identifiers, access times, and optionally viewing durations or navigation paths.

The term “preference information” refers to information derived from user state information and indicating one or more inferred tendencies of a user, including at least preferred categories, preferred brands, preferred price ranges, or preferred attributes of items.

The term “intention of the user” refers to a purpose or objective underlying an input by the user, including at least a desire to search for an item, to obtain a solution to a task, or to refine an existing proposal.

The term “task of the user” refers to a problem, requirement, or request expressed explicitly or implicitly by the user, for which a solution or support is to be generated by the system.

The term “context information” refers to structured information generated by analyzing character information and preference information, the structured information including at least an intention type, a target item, a budget range, and preference attributes, and being suitable for use as conditioning data for downstream processing.

The term “intention type” refers to a classification label or category indicating a class of intention of the user, including at least a product search intention, a problem-solving intention, or a follow-up refinement intention.

The term “target item” refers to an item, product, service, or content element that is relevant to the user's intention and task, and that may be proposed or described as a solution candidate.

The term “budget range” refers to information indicating at least one numerical range or categorical range of acceptable cost or price for a target item, as inferred from user state information or specified in character information.

The term “preference attributes” refers to attributes or features associated with a target item that are preferred by the user, including at least category attributes, brand attributes, color attributes, style attributes, or functional attributes.

The term “prompt sentence” refers to machine-readable text data constructed to be supplied as input to a generative AI model, the text data including at least context information and character information and optionally instruction content defining required output characteristics.

The term “generative AI model” refers to a machine learning model configured to generate natural language or structured output based on an input sequence, the machine learning model including at least a natural language processing function implemented by a neural network or similar architecture.

The term “natural language processing function” refers to a function of processing natural language input to perform at least one of understanding, transformation, or generation of natural language text.

The term “response information” refers to information output by a generative AI model in response to a prompt sentence, the information including at least a solution for the task of the user and proposal information of a target item suitable for the user.

The term “solution” refers to information that addresses the task of the user by providing at least an answer, an explanation, a procedure, or a recommended action.

The term “proposal information” refers to information that recommends one or more target items to the user, including at least item-level explanations, advantages, or suitability reasons.

The term “identification information” refers to data that uniquely or distinctively identifies a target item within a product information storage device, including at least an item code, item identifier, or similar key.

The term “product information storage device” refers to a storage apparatus or storage subsystem that stores attribute information relating to items, including at least item identifiers, descriptions, prices, stock status, and other item attributes.

The term “attribute information” refers to structured data describing properties of a target item, including at least category, brand, specifications, price, stock status, and optionally media resources.

The term “explanation information” refers to descriptive text, generated by a generative AI model or another processing function, that explains features or suitability of a target item or a solution.

The term “presentation information” refers to information generated for output to a user terminal, the information including at least explanation information and attribute information associated with one or more target items, and being formatted for visual or other sensory presentation.

The term “user terminal” refers to an endpoint device operated by a user, including at least a computing device having a display and an input interface, and capable of receiving presentation information from a server.

The term “inventory status information” refers to information indicating availability of a target item, including at least stock presence, stock quantity, or availability classification.

The term “price information” refers to information indicating one or more prices associated with a target item, including at least a base price, a discounted price, or a price range.

The term “list information” refers to presentation information that includes multiple target items arranged as a list, together with associated inventory status information, price information, and optionally explanation information.

The term “operation information” refers to information indicating operations performed by a user on presentation information or list information, including at least selection operations, non-selection, scrolling, or refinement actions.

The term “log information” refers to stored data representing operation information and associated metadata, including at least timestamps, user identification information, item identifiers, and context identifiers.

The term “control content” refers to parameters or rules that govern processing behavior of a system component, including at least generation processing of context information and generation processing of a prompt sentence.

The term “emotion analysis function” refers to a function of analyzing voice input or text data to estimate emotion information such as sentiment, affective state, or intensity, implemented by a software-implemented or hardware-implemented algorithm.

The term “emotion information” refers to structured information indicating an emotional state or sentiment inferred from input data of a user, including at least polarity (positive, neutral, negative) or categories such as satisfaction, frustration, or urgency.

The term “instruction content” refers to portions of a prompt sentence that explicitly or implicitly define constraints or desired characteristics of output to be generated by a generative AI model, including at least tone, detail level, style, or formatting.

The term “expression format” refers to one or more properties of output content generated by a generative AI model, including at least tone, politeness level, verbosity, structure, and style of natural language expressions.

The server implements the invention by executing a program on a hardware platform that includes at least one central processing unit, a main memory, a non-volatile storage device, and a network interface connected to a communication network. The server stores a speech processing module, a user state management module, a context generation module, a prompt generation module, a generative AI interface module, a product information management module, an emotion analysis module, and a logging and feedback module. The server executes these modules as cooperating processes or services under an operating system such as a general-purpose server operating system.

The terminal implements the invention by executing an application program on a hardware platform that includes at least a processor, a memory, a display, an audio input device, and a network interface. The terminal stores an audio capture component, a user interface component, a network communication component, and a local data management component. The terminal executes these components under a mobile or desktop operating system and interacts with the server over a network.

The user operates the terminal to provide voice input, to view presentation information, and to perform selection operations on items proposed by the system. The user interacts with graphical controls rendered by the terminal and thereby influences processing performed by the server.

The server uses the speech processing module to convert voice input into character information. The server receives digital audio data that represents the user's speech and applies a speech recognition algorithm implemented by a trained acoustic model and a language model. The server may utilize an external speech recognition service that provides neural-network-based speech recognition, where the acoustic model is a deep neural network taking as input a sequence of spectral feature vectors computed from the audio signal, and outputting probabilities over phonetic units. The server processes the resulting probabilities through a decoding algorithm such as a beam search with a language model that estimates the probability of word sequences. The server obtains a text sequence as character information and stores this sequence in memory together with a user identifier.

The server uses the user state management module to access user state information stored in a relational database or key-value store. The server stores purchase history information and browsing history information in normalized tables or collections. The server executes database queries that filter records by user identification information and a time range. The server computes aggregate statistics such as counts of category occurrences, average price values, and frequency of brand appearances by executing database aggregation operations. The server encodes these aggregated statistics into a structured feature vector, where each dimension corresponds to a category, a brand, a price bucket, or another attribute. The server thereby generates preference information that numerically represents tendencies of the user. The server uses the context generation module to analyze the character information and the preference information. The server applies a natural language understanding algorithm to the character information. The server may use a rule-based parser, a probabilistic parser, or a neural network model such as a transformer-based text encoder. The server tokenizes the text, assigns part-of-speech tags, and identifies named entities such as item types, brands, usage scenarios, and budget expressions. The server maps recognized entities to internal codes in a product taxonomy. The server combines these codes with the numerical preference feature vector to generate context information. The server encodes the context information as a data structure including fields such as an intention type, a target item category, a budget range, and preference attributes derived from both the real-time utterance and historical data.

The server improves computer technology by defining and using this context information as a compact, machine-usable representation that replaces ad hoc, repeated interpretation of raw text and raw logs. The server reduces processing load by caching and reusing the context structure across multiple internal modules and across multiple interactions within a session. The server thereby reduces redundant database queries and repeated natural language analysis, which decreases computation time and network traffic and improves scalability when many users simultaneously interact with the system.

The server uses the prompt generation module to construct a prompt sentence for a generative AI model. The server concatenates the character information, the context information, and explicit instruction content into a single linear text sequence. The server formats the prompt sentence according to a predetermined template that defines the ordering and labeling of segments. The server may, for example, create a prompt sentence such as:
“You are a generative AI model acting as an online shopping assistant.
User request: ‘I want a new smartphone case that is shock-resistant and not too expensive.’

### Context

Intent type: product search
Device: smartphone model category
User preferences: prefers dark colors, prefers mid-range prices, often selects shock-resistant accessories
Task: Propose 3 Suitable Cases With Reasons.

### Output Format

For each item: item_id, short explanation (1-2 sentences in English).”
The server may alternatively generate a prompt sentence such as:
“You are a generative AI model that generates solutions and item proposals based on user text and user history.
User text: ‘I need headphones that are comfortable for long online meetings.’
User purchase history: has bought office-related equipment in the mid-price range.
User browsing history: has frequently viewed noise-canceling headphones between 100 and 150 units of currency.
Please recommend 1-3 specific items, and for each item explain in concise English why it matches the user's needs, considering comfort and long-term use.”

The server uses the generative AI interface module to transmit the prompt sentence to a generative AI model deployed on a computing resource. The server communicates with the generative AI model through a network protocol. The generative AI model may be a transformer-based neural network trained on large-scale text data. The generative AI model includes an embedding layer that converts tokens of the prompt sentence into numerical vectors, multiple attention layers that compute context-aware representations of the tokens, and an output layer that predicts distributions over possible next tokens. The generative AI model is trained with a loss function such as cross-entropy between predicted token distributions and correct tokens, and the model parameters are updated by an optimization algorithm such as stochastic gradient descent with adaptive moment estimation.

The server uses internal rules and configuration parameters to control how the prompt sentence is generated and how the generative AI model is invoked. The server sets temperature, maximum output length, and decoding strategy, such as greedy decoding or nucleus sampling. The server configures these parameters based on context information, such as setting shorter maximum output for certain intention types or adjusting the style of the output based on emotion information.

The server uses the product information management module to interpret the response information generated by the generative AI model. The server parses the text of the response information, using either regular expression rules, a shallow parser, or a secondary model that extracts structured fields from the generated text. The server identifies item identifiers or other identification information and uses these identifiers to query a product information storage device. The product information storage device holds attribute information such as item descriptions, technical specifications, prices, and stock status. The server joins the explanation information produced by the generative AI model with the attribute information. The server constructs presentation information that can be rendered by the terminal as a list of recommended items with associated explanations.

The terminal receives the presentation information from the server via a network communication component. The terminal stores the presentation information in memory and renders a user interface. The terminal displays a list of target items with associated images, prices, inventory statuses, and explanations. The terminal provides controls that allow the user to select an item, request more details, or initiate a purchase. The terminal transmits the user's selection or non-selection operations to the server as operation information.

The server uses the logging and feedback module to store operation information as log information. The server records each user action together with user identification information, item identifiers, context identifiers, and timestamps. The server periodically analyzes log information using statistical or machine learning methods. The server computes metrics such as the probability that a recommended item was selected, the average time before selection, or the distribution of refinement queries. The server adjusts control content of the context generation module and prompt generation module based on these metrics. For example, the server may adjust the weights for different preference attributes when constructing context information or may modify the templates used for prompt sentences to emphasize highly predictive attributes. The server thereby systematically improves the accuracy of recommendations and reduces the frequency of ineffective proposals, which leads to improved computing efficiency and reduced network load.

The server optionally uses the emotion analysis module to analyze emotion information from the user's voice input. The server may extract acoustic features such as pitch, energy, speaking rate, and spectral characteristics, and may input these features into a classifier model such as a recurrent neural network or a transformer-based model trained to predict emotion categories. The server may also apply sentiment analysis to the character information to complement the acoustic-based emotion estimation. The server represents emotion information as a structured vector containing, for example, polarity and intensity values. The server adds this emotion information to the context information and uses it to control instruction content in the prompt sentence, such as directing the generative AI model to respond more concisely when frustration is detected, or to provide more reassurance when negative sentiment is present. The server thereby creates a feedback loop in which emotion information functions as a technical control parameter that modulates the generative process and improves user satisfaction without increasing computational complexity.

The server improves computer technology by using a structured prompt generation mechanism instead of sending raw or loosely formatted text to the generative AI model. By encoding context information, preference attributes, and emotion information into a deterministic structure within the prompt sentence, the server reduces variability in model behavior and increases the probability that the generated output can be automatically parsed and aligned with internal item identifiers. The server thus reduces post-processing complexity and error rates when mapping free-form text to item identifiers in the product information storage device. This strategy enables efficient, automated linking between neural-generated content and structured databases, which constitutes a technical improvement over generic, non-contextual content generation.

The server further improves computing performance by using a dedicated context data structure and caching strategy. The server computes context information once for a given session and stores it in fast-access memory or a cache. When the user issues follow-up queries, the server reuses and incrementally updates the context information instead of recomputing all aggregates from scratch. This caching reduces computation time, database access load, and network latency. The server also compresses context information into a compact representation, which reduces the size of prompt sentences and thereby decreases the input length to the generative AI model. Shorter prompt sentences reduce the number of tokens processed by the neural network and therefore reduce inference time and computational cost.

The server may implement multiple embodiments for the generative AI model interface. In one embodiment, the server directly hosts the generative AI model on a dedicated accelerator device, and the server schedules batches of prompt sentences for parallel processing. In another embodiment, the server uses an external cloud-based generative AI service and adjusts batch size and concurrency based on observed latency. The server can also maintain multiple generative AI models with different sizes or capabilities and select a specific model based on context information, such as selecting a smaller model for routine queries to conserve resources and a larger model for complex problem-solving tasks requiring more detailed reasoning.

The server may implement alternative algorithms for context generation. In one variation, the server uses a rule-based system that applies predetermined rules to character information and preference information to derive an intention type and target item. In another variation, the server uses a supervised learning classifier that takes as input a feature vector constructed from lexical features, semantic embeddings, and historical behavior features, and outputs an intention type and candidate categories. The server may use dimensionality reduction methods such as principal component analysis to compress high-dimensional behavior features before classification, thereby improving runtime efficiency.

The terminal may implement alternative presentation methods. In one embodiment, the terminal presents recommended items in a grid layout with images and short text fragments. In another embodiment, the terminal presents recommended items in a conversational interface, where explanation information is integrated into a chat-like display. The terminal may also support voice output by converting explanation information into synthesized speech using a text-to-speech engine, providing an additional modality while still relying on the same structured presentation information received from the server.

The server and the terminal together realize a system in which computation is not limited to automating human decision-making but instead modifies the internal functioning of the computer platform. By using structured context information, systematic prompt sentence construction, neural network-based generative processing, and feedback-driven parameter adjustment, the system achieves improved technical performance metrics such as reduced query latency, increased mapping accuracy between generated text and item identifiers, and reduced network traffic due to more concise and effective interactions. The system thereby provides a concrete improvement to computer-based recommendation and problem-solving technology.

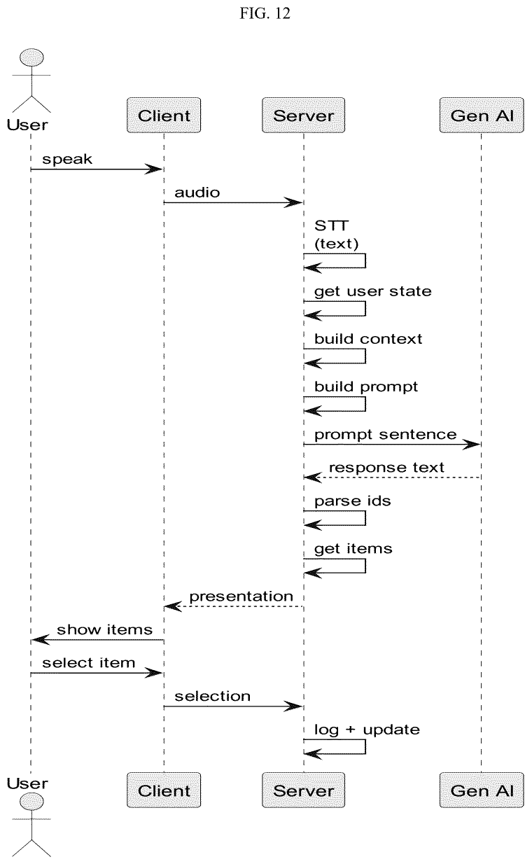

The following describes the processing flow using FIG. 12.

### Step 1

The user operates the terminal and provides voice input describing a desired item or a problem.
The terminal uses an audio capture function to sample the user's voice via a microphone and stores the sampled waveform as digital audio data in a buffer.
The terminal encodes the digital audio data into a compressed format together with metadata including a user ID, a session ID, and a language code as input to a network transmission process.
The terminal transmits the encoded audio data and the metadata to the server over a network as an HTTP request, and outputs a network packet stream toward the server.

### Step 2

The server receives, as input, the network packet stream that includes the encoded audio data and the metadata from the terminal.
The server decodes the compressed audio data into a raw audio signal and normalizes sampling rate and amplitude range to obtain a standardized audio frame sequence.
The server applies a speech processing function to the standardized audio frame sequence and computes spectral feature vectors such as Mel-frequency cepstral coefficients, which constitute an intermediate feature representation.
The server inputs the feature representation into a speech recognition algorithm, performs acoustic model and language model inference, and outputs character information as a text string representing the content of the user's utterance.

### Step 3

The server receives, as input, the character information and the user ID contained in the metadata.
The server issues database queries to a user state storage device using the user ID as a key and retrieves user state information consisting of purchase history information and browsing history information.
The server processes the purchase history information by grouping records by category, brand, and price range and computing aggregate statistics such as counts and averages, and generates numerical features that represent the user's purchasing tendencies.
The server processes the browsing history information by aggregating viewed item identifiers, page dwell times, and category frequencies and generates numerical features that represent the user's viewing tendencies, and outputs combined preference information as a structured feature set.

### Step 4

The server receives, as input, the character information and the preference information.
The server uses a natural language understanding function to tokenize the character information, assign part-of-speech tags, and detect entities representing item types, brands, budget expressions, and usage scenarios.
The server maps detected entities to internal codes in a product taxonomy and combines these codes with the numerical preference features to compute an intention type, a target item category, a budget range, and preference attributes.
The server packages these computed values into a context information structure in which each field is explicitly labeled, and outputs the context information for subsequent processing.

### Step 5

The server receives, as input, the character information and the context information.
The server constructs a prompt sentence by inserting the character information and the fields of the context information into a predefined template that specifies sections for “User request,” “Context,” “Task,” and “Output format.”
The server concatenates instruction content, the user's original text, and the structured context into a single linear text sequence and verifies that required sections such as intention type, target item, and budget range are included.
The server outputs the prompt sentence as a completed text instruction ready to be supplied to a generative AI model.

### Step 6

The server receives, as input, the prompt sentence.
The server transmits the prompt sentence to an external or internal generative AI model by encapsulating the prompt sentence in a request message conforming to an application programming interface specification.
The server sets model parameters such as a model identifier, a temperature value, and a maximum token count and sends these parameters together with the prompt sentence to the generative AI model.
The server receives, as output, response information from the generative AI model, the response information including natural language text that describes solution content and proposal information for one or more target items.

### Step 7

The server receives, as input, the response information.
The server analyzes the response information using pattern matching rules or a parsing function to extract identification information such as item identifiers, item codes, or category labels from the natural language text.
The server validates the extracted identification information by checking existence and consistency against a product information storage device, discarding invalid identifiers or resolving ambiguous references.
The server outputs a cleaned set of item identifiers together with associated explanation segments extracted from the response information.

### Step 8

The server receives, as input, the cleaned set of item identifiers and the associated explanation segments.
The server queries the product information storage device using the item identifiers as keys and retrieves attribute information including item descriptions, specifications, prices, and inventory status.
The server associates each explanation segment with the corresponding attribute information and constructs presentation information by merging the natural language explanations with structured attribute fields for each target item.
The server outputs the presentation information as a data structure suitable for rendering by the terminal, including lists of items with their attributes and explanations.

### Step 9

The server receives, as input, the presentation information and the user ID or session ID.
The server transmits the presentation information to the terminal over the network as a response message to a prior request.
The server logs the context identifier, the prompt sentence used, the item identifiers included in the presentation information, and a timestamp as log information in a logging storage device.
The server outputs an acknowledgment of successful transmission and retains the log information for potential later analysis and feedback control.

### Step 10

The terminal receives, as input, the presentation information from the server.
The terminal parses the presentation information into internal data objects representing target items, each containing attribute information and an explanation text.
The terminal renders a user interface on the display, generates visual components such as item tiles, images, text labels, and action buttons, and arranges these components according to a layout rule.
The terminal outputs a graphical screen showing recommended target items and their explanations to the user.

### Step 11

The user views, as input, the graphical screen containing the recommended items and explanations.
The user performs one or more operations such as tapping a specific item, scrolling the list, or activating a filter or refinement control.
The user's operation generates selection or refinement instructions that are captured by the input handling logic of the terminal as operation information.
The terminal outputs the operation information and the identifiers of the affected items or actions to the server as an input for logging and potential further processing.

### Step 12

The server receives, as input, the operation information and related identifiers from the terminal.
The server stores the operation information, together with the associated context information, prompt sentence identifier, and item identifiers, as log information in a logging storage device.
The server periodically processes accumulated log information using statistical analysis or machine learning algorithms to update control parameters for context generation and prompt generation, such as adjusting weights for different preference attributes.
The server outputs updated control content that will be applied in subsequent executions of context generation and prompt sentence construction, thereby refining the behavior of the system over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented inquiry response systems that utilize natural language processing or generative models often treat a user's input as an isolated text string and do not systematically combine the input with user state information or contextual information stored across heterogeneous information management systems. As a result, the generated responses tend to be generic, lack personalization, and frequently require multiple follow-up interactions, thereby increasing server load, network traffic, and processing latency.

Further, in many existing architectures, prompt sentences for a generative AI model are constructed in an ad-hoc manner at the application layer, without a standardized internal representation of user intent, entities, and user state. This causes inefficiencies in the data processing pipeline, such as redundant parsing, repeated database queries, and inconsistent prompt quality across different services. Consequently, the utilization of computing resources in the server, such as processing units, memory units, and communication interfaces, is sub-optimal, and the overall throughput and responsiveness of the inquiry handling system are degraded.

Still further, conventional systems do not adequately integrate emotion analysis into the core prompt generation flow. Emotion information, if processed at all, is often handled as a separate overlay, not as structured data that directly affects prompt construction. This results in an inability of the system to adaptively control the behavior of the generative AI model based on detected emotional states, such as frustration or urgency, and leads to sub-optimal response strategies and increased user dissatisfaction.

In addition, existing systems typically lack a unified mechanism in the server to transform generated solution information into output formats optimized for both machine processing and human consumption, including downstream terminals and optional support personnel terminals. As a result, there is no consistent server-side control over formatting, validation, and routing of solutions, which leads to fragmented logic, increased code complexity, and additional failure points in distributed deployments.

Accordingly, there is a need for an improved computer-implemented technique that, within a server, (i) acquires inquiry information from a user through audio or character channels, (ii) converts and normalizes the information into structured analysis result data, (iii) combines such data with user state information to form task context data, (iv) generates high-quality prompt sentences for a generative AI model based on template information and rule information, (v) integrates emotion information as a first-class factor in prompt generation, and (vi) post-processes and delivers solution information in a controlled and efficient manner. Such an improvement should enhance the technical operation of the server by reducing redundant processing, improving the quality and relevance of generated responses, lowering latency, and increasing the robustness and scalability of the entire inquiry handling pipeline.

The specific processing by the specific processing unit 290 of the data processing device 12 in Example 2 is realized by the following means.

The present invention provides a server comprising a processor configured to acquire inquiry information from a user as audio information or character information via a communication interface, to perform voice processing on the audio information to generate inquiry character information, to execute natural language processing on the inquiry character information or on character information input by the user to generate analysis result data including intent information and element information, to obtain user state information from an information management apparatus based on user identification information, to combine the analysis result data with the user state information to generate task context data and specify a user task, to construct a prompt sentence for a generative AI model based on the task context data and on template information and rule information so as to generate and record prompt data, to send the prompt data to the generative AI model and acquire response information generated by the generative AI model as solution information, to optionally perform emotion analysis on the inquiry information and incorporate resulting emotion information into the task context data and the prompt sentence, and to perform format conversion processing or content checking processing on the solution information to generate output solution information and send the output solution information to a user terminal or a support personnel terminal for presentation to the user. This enables an improvement of the functioning of the server and associated computing resources by providing a structured and integrated data processing pipeline that generates context-aware, emotion-sensitive prompt sentences and high-quality solution information, reduces redundant processing and network interactions, and enhances responsiveness, scalability, and reliability of computer-implemented inquiry handling.

The term “inquiry information” refers to information representing a question, request, or statement provided by a user to the system, including at least one of audio information and character information.

The term “audio information” refers to data representing sound signals obtained from a user, including voice signals captured by an input device and encoded in any digital audio format.

The term “character information” refers to data representing text in a symbolic form, including characters, letters, numerals, and punctuation, which can be processed by a computing device.

The term “identifier” refers to information used to uniquely or specifically identify an inquiry, a user, a session, or another entity within the system, including a code, a token, or a numerical value.

The term “communication path” refers to a logical or physical channel for transmitting data between devices or components, including wired or wireless networks and communication interfaces.

The term “voice processing function” refers to processing performed by hardware, software, or a combination thereof, configured to analyze audio information and convert the audio information into character information by using speech recognition or similar techniques.

The term “inquiry character information” refers to character information obtained by converting audio information provided by a user, and representing the content of the user's inquiry.

The term “natural language processing function” refers to processing performed by hardware, software, or a combination thereof, configured to analyze character information expressed in a natural language and derive structured information such as intent information and element information.

The term “structuring processing” refers to processing that transforms unstructured or semi-structured inquiry character information into structured data having predetermined fields or attributes, suitable for subsequent computational operations.

The term “intent information” refers to data indicating a purpose, goal, or type of action that a user desires to achieve by the inquiry, such as a request category or operation type.

The term “element information” refers to data indicating specific items, entities, parameters, or attributes included in the inquiry information, such as product identifiers, dates, account identifiers, or other relevant details.

The term “analysis result data” refers to data generated by the natural language processing function that includes at least the intent information and the element information derived from the inquiry character information or character information.

The term “user identification information” refers to information used to identify a user within the system, including an account identifier, a login identifier, or another unique identification value.

The term “information management apparatus” refers to an apparatus, including hardware and software resources, configured to store, manage, and provide user state information, such as databases, storage systems, or management servers.

The term “user state information” refers to information indicating a status or condition of a user in relation to the system, including subscription status, transaction history, account status, preferences, or interaction history.

The term “task context data” refers to data obtained by combining the analysis result data with the user state information, and representing a contextualized description of a user's task or issue to be solved.

The term “user task” refers to a specific problem, request, or objective associated with a user that is identified based on the task context data.

The term “template information” refers to information defining one or more text patterns, formats, or frameworks used for constructing a prompt sentence, including fixed phrases and variable placeholders.

The term “rule information” refers to information defining logical conditions, selection criteria, or transformation rules used in combination with the template information to construct or modify a prompt sentence.

The term “prompt sentence” refers to a natural language text generated for input to a generative AI model, the text describing at least the user's inquiry, the user task, and relevant context information.

The term “prompt data” refers to data representing the prompt sentence in a form suitable for storage, transmission, and input to the generative AI model.

The term “generative AI model” refers to a computational model using machine learning or artificial intelligence techniques, configured to generate response information in a natural language or another format based on an input prompt sentence.

The term “response information” refers to information generated by the generative AI model in response to the prompt sentence, including text representing an answer, explanation, or instruction.

The term “solution information” refers to response information obtained from the generative AI model and treated as a candidate solution for the user task.

The term “emotion analysis processing” refers to processing configured to analyze inquiry information to detect or estimate emotional states, such as satisfaction, frustration, or urgency, and to output emotion information.

The term “emotion information” refers to data representing one or more emotional states or attributes derived from the inquiry information by the emotion analysis processing.

The term “format conversion processing” refers to processing configured to convert solution information from a first format or structure into a second format or structure suitable for presentation or further processing, such as structured text, markup, or audio-ready data.

The term “content checking processing” refers to processing configured to verify, validate, or adjust the content of solution information according to predetermined criteria, such as policy compliance, safety, or correctness.

The term “output solution information” refers to solution information after application of format conversion processing and/or content checking processing, prepared for provision to the user.

The term “user terminal” refers to an information processing device operated by a user, including a mobile device, a computer, or another communication device capable of transmitting and receiving data to and from the server.

The term “support personnel terminal” refers to an information processing device operated by support personnel, configured to receive, display, and edit solution information and output solution information.

The term “voice synthesis data format” refers to data formatted for use by a text-to-speech or voice synthesis function, such as text annotated with prosody information or encoded in a machine-readable specification for audio generation.

In one embodiment, a server includes a processor, a memory, a storage device, and a communication interface connected via an internal bus. The server executes a program stored in the storage device and loaded into the memory. The program causes the server to perform acquisition, analysis, prompt generation, communication with a generative AI model, and post-processing of responses. The server communicates with one or more terminals operated by a user or support personnel via a network such as the Internet.

A terminal includes an input device such as a microphone and a keyboard, an output device such as a display and a speaker, a communication module, and a local processor. The terminal executes an application that interacts with the server by sending inquiry information and receiving solution information. The user operates the terminal to input inquiry information as audio information or character information and to view or listen to responses. The server utilizes a voice processing module implemented as software executed on a central processing unit and optionally on a graphics processing unit. In one example, the server executes a speech recognition engine based on a neural network architecture such as a recurrent neural network or a transformer network. The server applies acoustic feature extraction, including mel-frequency cepstral coefficients, and passes the features through multiple neural network layers. The neural network outputs probability distributions over character or phoneme sequences, which the server decodes into character information using a beam search algorithm. The server thereby converts audio information into inquiry character information with improved accuracy and reduced error rate compared to simple keyword detection.

The server further utilizes a natural language processing module implemented using a library or framework such as a tokenization engine, a part-of-speech tagger, and a contextual language model. In one example, the server executes a transformer-based encoder network that receives tokenized character information and outputs contextual embeddings. The server applies a classification layer on top of the embeddings to derive intent information and applies a sequence labeling layer to derive element information. The server organizes the resulting data into a structured representation stored in memory, for example as a record including fields for intent, entities, confidence scores, and original text. This structuring enables subsequent processing to access specific fields directly, reducing redundant parsing and improving processing speed.

The server accesses an information management apparatus that stores user state information in a database system such as a relational database or a key-value store. The server sends queries using a standardized query language to retrieve data such as subscription status, transaction records, account lock information, and prior inquiry history. The server combines this user state information with the analysis result data in a dedicated data structure called task context data. The task context data may include fields for user intent, relevant entities, user status attributes, and derived conditions such as eligibility for a return or applicability of a particular procedure.

The server generates a prompt sentence for a generative AI model by applying template information and rule information to the task context data. The server stores template information as a set of pattern strings with placeholders, such as:
“The user asked: ‘[USER_INQUIRY_TEXT]’. The user is associated with [USER_STATUS_SUMMARY]. Explain the appropriate procedure step by step in polite and easy-to-understand language.”

The server applies rule information that specifies which template to select and how to fill placeholders based on conditions such as the intent, the type of product, or the detected urgency. For example, if the intent corresponds to a product return and the user state information indicates that a product “Wireless Earbuds Model X” was purchased 10 days ago with a 30-day return period, the server constructs a prompt sentence such as:
“The user asked: ‘Please tell me how to return a product.’ The user purchased ‘Wireless Earbuds Model X’ 10 days ago, and the product is within a 30-day return period under the applicable policy. Explain the return procedure step by step, including packaging, required documents, and where to send the product. Use polite and easy-to-understand language.”

In another example, if the intent corresponds to an account access problem, the server constructs a prompt sentence such as:
“The user said: ‘I forgot my account password and cannot log in.’ The user account is currently locked due to multiple failed login attempts. Describe how the user can reset the password and unlock the account. Include both web and mobile application procedures.”

The server records the generated prompt sentence as prompt data in a storage area. By using explicit templates and rule sets, the server reduces variability in prompt quality and enforces consistent inclusion of context, which in turn improves response quality and reduces the need for repeated user interactions.

The server sends the prompt data to a generative AI model via the communication interface. The generative AI model resides either on a separate computing system or on the same server. In one embodiment, the generative AI model is implemented as a transformer-based neural network consisting of an embedding layer, a plurality of self-attention layers, feed-forward layers, and an output projection layer. The server tokenizes the prompt sentence into subword units and transmits the token sequence to the generative AI model. The generative AI model processes the input tokens layer by layer, computing attention scores and intermediate vectors, and generates output tokens representing response information.

The server configures operation parameters of the generative AI model, such as a temperature parameter, a maximum number of output tokens, and a top-k or top-p sampling parameter, by including corresponding values in a request message. By adjusting these parameters, the server controls the trade-off between determinism, diversity, and response length, which is a technical effect that influences computational load and memory usage on the model-hosting hardware.

The server optionally applies emotion analysis processing to the inquiry information. In one example, the server uses a classification network that receives embeddings of the inquiry character information and outputs one or more emotion labels such as “neutral”, “frustrated”, or “urgent”. The server encodes the emotion information into the task context data and modifies the prompt sentence accordingly. For instance, when frustration is detected, the server may generate a prompt sentence including instructions such as:
“The user seems frustrated based on the wording and tone. Respond in a calm and empathetic manner, and provide a concise and clear explanation.”

By incorporating emotion information at the prompt construction stage, the server enables the generative AI model to adjust its output style and content. This adjustment occurs through structured modifications of the prompt sentence rather than through ad-hoc post-processing, thereby reducing the need for repeated model calls and improving latency.

The server receives the response information from the generative AI model and performs format conversion processing and content checking processing. During format conversion processing, the server transforms the response information into a standardized internal format, such as a list of steps, a set of bullet points, or a question-and-answer pair representation. The server uses predetermined parsing rules or lightweight natural language segmentation to identify step boundaries and key instructions. The server stores the formatted output solution information in a data structure that includes fields for presentation type, display order, and emphasis flags.

During content checking processing, the server applies rule-based filters and optionally a secondary classifier to detect potential violations of policies or inconsistencies with stored user state information. For example, if the response refers to a return period longer than what is stored in the database, the server can identify the discrepancy by comparing dates and periods. The server may then adjust or flag the response and optionally route it to a support personnel terminal for review. This internal validation step reduces incorrect or non-compliant responses and decreases the risk of erroneous behavior at the user side.

The server sends the output solution information to the terminal as text data or as data prepared for voice synthesis. When output as text, the server attaches metadata such as formatting instructions. The terminal receives the data and renders it on the display device as a structured layout, for example as numbered steps for procedures. When voice output is desired, the server converts the output solution information into a voice synthesis data format compatible with a text-to-speech engine. The terminal uses the text-to-speech engine to generate audio output, which is played through the speaker. This flow provides an end-to-end technical solution from audio acquisition to synthesized audio output with minimal human intervention.

The server improves computer technology in several ways. First, by maintaining a structured pipeline composed of voice processing, natural language analysis, context combination, template-based prompt generation, and carefully controlled model invocation, the server avoids redundant parsing and repeated database access that occur in naive implementations. The server stores intermediate results in well-defined data structures and reuses them across modules, reducing computation time and memory usage. Second, the server's explicit separation of analysis result data and task context data allows for efficient indexing and caching, which improves throughput and supports a larger number of concurrent inquiries. Third, the server's rule-based prompt construction mechanism systematically incorporates user state information and emotion information into the prompt sentence. This design leverages the strengths of the generative AI model by providing it with richer and more relevant context in a structured manner, which results in higher response accuracy and fewer follow-up requests. Reduced follow-up requests lead to fewer model calls and less network traffic, thereby reducing load on the computing infrastructure.

Fourth, the server uses specialized neural network components with clearly defined loss functions and training procedures. For example, the intent classification model is trained using a cross-entropy loss over intent labels, and the named entity recognition model is trained using sequence labeling loss over token tags. The emotion analysis model is trained on labeled sentences with emotion annotations, using supervised learning and gradient-based weight updates. The generative AI model is pre-trained on large corpora and optionally fine-tuned on domain-specific data with an objective function that minimizes prediction error over token sequences. By specifying these training and inference procedures, the server employs non-conventional, computer-oriented processing steps that extend beyond human mental processes.

In addition, the server can employ optimization techniques such as model quantization, caching of frequently used prompts and outputs, and batching of multiple prompt sentences for simultaneous processing within the generative AI model. These techniques reduce computational overhead and memory bandwidth consumption. The server may also adaptively select model variants with different parameter sizes depending on the complexity of the user task, thereby balancing quality against resource usage.

The terminal benefits from the server's structured processing by receiving output solution information in a form that is easy to render and interact with. The user interacts with the terminal to provide feedback such as whether the provided solution is helpful. The server can incorporate such feedback into subsequent processing by updating rule information or by adjusting the selection of templates. Over time, the server can improve its internal configuration and data flows, further enhancing response speed and quality.

In another embodiment, the server operates in a deployment where the generative AI model resides on a dedicated inference accelerator device. The server manages scheduling of prompt sentences and allocation of hardware resources to avoid contention and latency spikes. The server can prioritize inquiries with detected urgent emotion information, placing them ahead in the processing queue. This scheduling behavior directly controls usage of hardware resources and represents a technical improvement to resource management in distributed inference systems.

In another embodiment, the server supports multiple languages by loading language-specific models and templates. The server detects the language of the inquiry character information during natural language processing and selects appropriate models and templates. This reduces model confusion and improves recognition and generation accuracy in multilingual environments.

Overall, the server, terminal, and user cooperate in a system where the server performs non-conventional, structured processing to generate and deliver context-aware, emotion-sensitive solutions. The described architecture, data structures, and processing flows are designed to improve the functioning of computer systems, including reducing latency, enhancing accuracy, optimizing resource usage, and providing robust and scalable handling of inquiries using a generative AI model and structured prompt sentences.

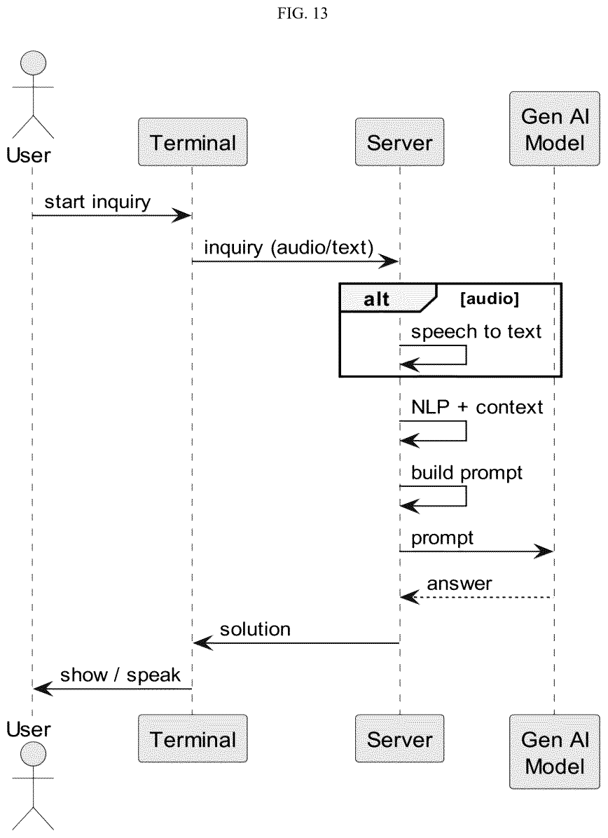

The following describes the processing flow using FIG. 13.

### Step 1

The user operates the terminal to start an inquiry session.
The user provides input as audio by speaking into a microphone of the terminal or as text by typing into a text input field.
The terminal receives the raw input as either audio samples (for example, 16-bit PCM frames) or character strings (for example, UTF-8 encoded text).
The terminal packages the input together with metadata such as a user identifier, a device identifier, a timestamp, and a session identifier.
The terminal sends a request containing the inquiry information and the metadata to the server via a network connection using a communication protocol, such as HTTPS.
Input: user speech signal or typed text, user and device metadata.
Output: a network request message containing inquiry information and metadata.

### Step 2

The server receives the network request from the terminal through a communication interface.
The server verifies the request by checking authentication tokens, validating message format, and confirming the presence of required fields such as user identifier and inquiry payload.
The server assigns or confirms a unique inquiry identifier and records the raw inquiry information and associated metadata in a storage device for logging and traceability.
Input: network request containing inquiry information and metadata.
Output: stored record containing raw inquiry information, metadata, and an inquiry identifier.

### Step 3

The server determines whether the inquiry information includes audio information.
When the inquiry contains audio information, the server invokes a voice processing module.
The server loads the audio samples from storage or from the request body and performs preprocessing such as normalization of amplitude and segmentation into frames.
The server applies a speech recognition model that converts the audio frames into character sequences by computing acoustic features and passing them through a neural network, then decoding probabilities into text.
The server stores the resulting character information as inquiry character information linked to the inquiry identifier.
Input: audio information associated with an inquiry identifier.
Output: inquiry character information representing the transcribed content of the audio.

### Step 4

The server selects inquiry character information as the text to analyze, either from the transcription of audio or from the original text provided by the user.
The server normalizes the text by unifying character types, removing unnecessary symbols, and correcting obvious recognition artifacts.
The server feeds the normalized text into a natural language processing module, which tokenizes the text and computes contextual embeddings for each token.
The server applies an intent classification layer to obtain an intent label and applies a sequence labeling layer to obtain element information such as entities, dates, and identifiers.
The server combines the intent label, the extracted entities, confidence scores, and the normalized text into analysis result data stored as a structured record.
Input: normalized inquiry character information.
Output: analysis result data including intent information, element information, and related attributes.

### Step 5

The server uses the user identifier from the metadata to query an information management apparatus.
The server issues one or more data retrieval operations, such as database queries, to obtain user state information including subscription details, transaction records, account status, and historical inquiry information.
The server merges the retrieved user state information with the analysis result data to build task context data.
The server derives additional context attributes, such as eligibility for certain procedures or the most relevant transaction record, by applying rule-based logic to the combined data.
Input: analysis result data, user identifier, and records in the information management apparatus.
Output: task context data describing the user task and relevant conditions.

### Step 6

The server performs emotion analysis on the inquiry character information or on features derived from the audio when emotion processing is enabled.
The server feeds text embeddings or acoustic features into an emotion classification model and obtains one or more emotion labels along with confidence scores.
The server appends the emotion information to the task context data as additional fields, such as emotion type and intensity.
The server updates any derived context attributes that depend on emotion, for example by marking the task as urgent when strong frustration is detected.
Input: inquiry character information or audio features, task context data.
Output: updated task context data including emotion information.

### Step 7

The server selects a prompt template based on the intent information, user state information, and emotion information contained in the task context data.
The server retrieves template information and rule information from configuration storage, including pattern strings with placeholders and selection rules.
The server fills the placeholders with concrete values such as the user's question, product names, dates, account status descriptions, and emotion-related instructions.
The server constructs a complete prompt sentence that encapsulates the user's inquiry, the task context, and guidance for the generative AI model.
The server stores the resulting text as prompt data associated with the inquiry identifier.
Input: task context data, template information, rule information.
Output: prompt data including a fully constructed prompt sentence.

### Step 8

The server prepares a request message for the generative AI model by encoding the prompt sentence into tokens or another representation accepted by the model interface.
The server sets generation parameters such as maximum output length, sampling strategy, and temperature, based on configuration and task properties.
The server sends the request containing the prompt data and parameters to the generative AI model through a communication interface, which may be an internal call or a network request to a remote model host.
Input: prompt data and generation parameters.
Output: a model request transmitted to the generative AI model.

### Step 9

The server receives a response from the generative AI model containing generated text tokens or character information that represent response information.
The server reconstructs the generated tokens into a coherent text string and associates this text with the inquiry identifier as solution information.
The server checks for incomplete or malformed outputs and, if necessary, applies fallback procedures such as truncating at sentence boundaries or re-requesting generation under adjusted parameters.
Input: generated tokens or text from the generative AI model.
Output: solution information representing the model-generated answer.

### Step 10

The server performs format conversion processing on the solution information to adapt it to internal presentation structures.
The server analyzes the text to detect structures such as steps, bullet points, or sections, using pattern rules or lightweight parsing.
The server converts the solution information into output solution information with explicit structural markers, such as an ordered list of steps or labeled sections.
The server performs content checking processing to verify that the output solution information complies with policies and is consistent with the user state information by comparing referenced conditions with stored data.
Input: solution information, user state information, policy rules.
Output: validated and structured output solution information.

### Step 11

The server decides the delivery path based on configuration, task type, and any risk indicators from content checking.
The server routes the output solution information either directly to a user terminal or first to a support personnel terminal for review.
When routing to a support personnel terminal, the server encapsulates the output solution information together with task context data and sends it via a communication interface so that a human operator can view and optionally modify the content.
Input: output solution information, routing rules, risk indicators.
Output: a delivery instruction and a message sent to the selected terminal.

### Step 12

The terminal operated by support personnel receives the routed output solution information when human review is required.
The support personnel uses the terminal to inspect the proposed response and may edit the text, adjust instructions, or add clarifications.
The terminal sends the reviewed version of the solution back to the server, which updates the stored output solution information with the finalized content.
Input: output solution information, task context as displayed on the support personnel terminal.
Output: finalized output solution information returned to the server.

### Step 13

The server prepares the finalized output solution information for delivery to the user terminal.
The server converts the structured representation into a text format suitable for display and optionally into a voice synthesis data format for text-to-speech rendering.
The server constructs a response message containing the finalized text and any presentation metadata, and sends the message to the user terminal via the network.
Input: finalized output solution information.
Output: response message addressed to the user terminal.

### Step 14

The terminal receives the response message from the server and parses the contained text and metadata.
The terminal renders the answer on the display as formatted text, such as numbered steps or highlighted sections, according to the metadata.
When voice output is enabled, the terminal passes the text to a text-to-speech engine and plays the synthesized audio through the speaker for the user.
Input: response message from the server.
Output: displayed text on the terminal screen and, when enabled, audio output of the solution.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional voice-based support systems generally perform speech recognition to obtain text from user speech and then apply fixed, rule-based logic to generate responses. Such systems suffer from several technical limitations at the level of computer processing and resource utilization. First, a processing apparatus typically handles audio input, user state information, and response generation as separate, loosely coupled functions, without a unified intermediate representation of the user's task. As a result, the processor cannot efficiently determine which parts of large user-history data sets or contextual data are actually relevant to a current query, leading to unnecessary database access, redundant computations, and increased latency.

Second, conventional systems do not systematically construct input to a generative AI model as a machine-oriented, structured prompt sentence that encodes both a normalized representation of the user's task and the user's contextual state. Instead, the systems either do not use generative models at all, or provide them with raw or loosely formatted user text. This prevents the processing apparatus from fully leveraging the reasoning capabilities of a generative AI model, causes non-deterministic or inconsistent responses, and requires additional ad hoc post-processing, which further increases processing time and complexity. Third, known approaches treat emotional information, if used at all, as an auxiliary, human-facing parameter rather than as a first-class input to the machine-side processing pipeline. Emotion analysis results are not consistently embedded into the prompt sentence for a generative AI model, nor are they used to algorithmically adjust content and expression style of machine-generated responses. Consequently, the processor cannot systematically adapt computational behavior—such as prompt construction, response selection, and formatting—to the detected emotional state of the user. This leads to technically suboptimal use of computational resources, since the same generic processing path is executed regardless of context, often resulting in multiple ineffective interaction cycles and increased overall system load.

Fourth, because prior systems lack a clearly defined, structured “task object” and “emotion object” that flow through the processing pipeline, it is difficult to log, reproduce, and optimize system behavior. The absence of machine-usable intermediate representations makes it harder to implement caching, query optimization, and fine-grained control of generative model calls. This limits scalability when the number of users and interactions grows, and leads to degraded responsiveness and throughput of the underlying computing infrastructure.

Accordingly, there is a need for a computer-implemented system and method that improve the way a processor acquires and integrates voice input, user state information, and emotion information, that generate a structured representation of a user's task, that construct a prompt sentence for a generative AI model including such structured information, and that algorithmically adjust both the prompt sentence and the final response content and style based on the user's state and emotional condition. By organizing the entire pipeline around machine-readable intermediate structures and controlled prompt generation, the system can reduce unnecessary computation, improve consistency and relevance of generated responses, and thereby improve the overall performance and technical operation of the computer system itself.

The specific processing by the specific processing unit 290 of the data processing device 12 in Application Example 2 is realized by the following means.

The present invention provides a server comprising a processor configured to acquire voice data of a user from a terminal device and convert a voice signal included in the voice data into character information by using a speech recognition technique; to acquire, on the basis of identification information of the user, user state information and past history information from an information storage device, to integrate the character information with the user state information and the past history information so as to specify a task of the user, and to generate structured information representing the task; to generate a prompt sentence for input to a generative AI model on the basis of the structured information representing the task and the user state information, and to cause the generative AI model to generate response information including a solution for the task by inputting the prompt sentence to the generative AI model; to apply an emotion analysis technique to at least one of the voice data and the character information to generate emotion information indicating an emotional state of the user, to embed the emotion information together with the structured information representing the task into the prompt sentence, and to adjust at least one of content and expression style of the prompt sentence and the response information on the basis of the emotion information and the user state information so as to generate final response information in which at least one of politeness, level of detail, and guidance procedure is changed in accordance with the emotional state of the user; and to transmit the final response information to the terminal device so that the final response information is provided to the user via the terminal device. This enables the computer system to internally construct and utilize machine-readable intermediate representations of a user task and emotional state, to generate controlled prompt sentences for a generative AI model that encode relevant contextual and emotional information, to reduce unnecessary database access and model calls, to systematically tailor the content and style of generated responses, and thereby to improve response relevance, processing efficiency, scalability, and overall technical performance of the underlying computing infrastructure.

The term “voice data” refers to digital data representing an acoustic signal produced by a user, including any sampled, encoded, or compressed audio signal that can be processed by a computing device.

The term “voice signal” refers to an analog or digital representation of spoken sound generated by a user, which is suitable for analysis by a speech recognition technique.

The term “terminal device” refers to an information processing device used by a user to input or receive information, including but not limited to a portable terminal, a mobile communication device, a computing device, or an in-vehicle device.

The term “speech recognition technique” refers to a computational technique that analyzes a voice signal and outputs character information corresponding to words or phrases spoken by a user.

The term “character information” refers to text data obtained from a voice signal or other input, which digitally represents the linguistic content of a user's utterance.

The term “identification information” refers to information that uniquely or pseudo-uniquely identifies a user or a user session, such as a user identifier, an account identifier, or a session identifier.

The term “information storage device” refers to a hardware and software combination used to store and manage data, including but not limited to a database system, a storage medium, or a data repository.

The term “user state information” refers to information indicating a state or condition of a user, including at least one of account data, configuration data, service usage data, or other status-related data associated with the user.

The term “past history information” refers to data representing past interactions or events related to a user, including at least one of inquiry history, transaction history, or support history.

The term “task of the user” refers to a problem, request, or objective that a user desires to be resolved or achieved by interaction with the system.

The term “structured information representing the task” refers to data in a machine-readable format that describes a task of the user by using one or more fields, labels, or attributes, and that is suitable for further processing by a computing device.

The term “generative AI model” refers to a computational model based on artificial intelligence that generates natural-language or other content in response to input data, by using learned parameters or patterns.

The term “prompt sentence” refers to a textual input, including instructions, context, and user-related information, which is provided to a generative AI model to control or guide generation of response information.

The term “response information” refers to information generated by a generative AI model in response to a prompt sentence, including at least one of an explanation, an instruction, or a proposal that addresses a task of the user.

The term “solution for the task” refers to information included in the response information that provides a concrete method, procedure, or recommendation for resolving or addressing the task of the user.

The term “post-processing” refers to processing performed on response information after generation by a generative AI model, including at least one of reformatting, editing, filtering, or augmenting the response information.

The term “final response information” refers to response information that has been subjected to post-processing and is formatted or adapted for presentation to a user through a terminal device.

The term “emotion analysis technique” refers to a computational technique that analyzes at least one of voice data and character information to estimate or classify an emotional state of a user.

The term “emotion information” refers to data indicating an estimated emotional state of a user, including at least one of an emotion label, an emotion category, an emotion score, or a time-series of emotional states.

The term “emotional state of the user” refers to a psychological or affective condition of a user at a given time, such as anger, frustration, calmness, satisfaction, or neutrality, as estimated by an emotion analysis technique.

The term “expression style” refers to a manner in which information is expressed, including at least one of tone, politeness level, verbosity, formality, or structure of a generated sentence.

The term “politeness” refers to a property of expression style that indicates a degree of courtesy or formality in language used in response information or final response information.

The term “level of detail” refers to a degree of granularity or amount of information contained in generated content, including whether the content is summarized, high-level, or step-by-step and detailed.

The term “guidance procedure” refers to an ordered set of instructions, steps, or actions presented to a user to direct the user toward resolving a task or performing an operation.

In one embodiment, a server cooperates with a terminal and a user to implement a system that acquires user voice input, derives a structured representation of a user task and emotional state, constructs a controlled prompt sentence for a generative AI model, receives generated response information, and produces a final response adapted to the user's context and emotion. The following description illustrates exemplary hardware and software configurations, data structures, processing modules, and technical effects that enable implementation of the claimed invention.

A server includes at least one processor, a memory, a network interface, and a storage device. The processor may be implemented by a general-purpose central processing unit (CPU) or a combination of a CPU and a graphics processing unit (GPU). The memory stores executable instructions and data structures. The storage device may include a local solid-state drive, a magnetic disk, or a network-attached storage. The server executes an operating system such as a generic server operating system and runs middleware components such as a web application framework, an application server, and a database management system.

A terminal includes a processor, a microphone, a speaker, a display, a memory, and a network interface. The terminal executes a client application that provides a user interface for voice input and presentation of responses. The terminal may be implemented as a portable information device, a vehicle-mounted device, or another information processing device.

A user interacts with the terminal by speaking into the microphone and by viewing or listening to responses on the display or speaker. The user does not require technical knowledge of the internal processing in the server.

The server implements a plurality of software modules, including at least a voice acquisition module, a speech recognition interface module, a user state management module, a task structuring module, an emotion analysis module, a prompt generation module, a generative AI interface module, a response post-processing module, and a communication module. Each module operates on explicit data structures and uses particular algorithms so that overall system performance and accuracy are improved compared with conventional systems.

The server uses a speech recognition interface module to integrate with a speech recognition engine. The speech recognition engine may be provided by a cloud-based speech recognition service or by an on-premise speech recognizer implementing a deep neural network architecture such as a convolutional-recurrent network or a transformer-based acoustic model trained with a connectionist temporal classification loss. The server sends encoded audio frames to the speech recognition engine via a network API, receives recognition hypotheses as text strings with confidence scores, and stores character information associated with user identifiers. By using a neural-network-based speech recognition engine with acoustic modeling and language modeling optimized for conversational queries, the server reduces word error rate, which in turn reduces downstream misclassification of user tasks.

The server uses a user state management module backed by a structured database, for example a relational database system. The database stores tables for user state information and past history information. The user state information may include columns for account status, service plan, device type, location region, and configuration preferences. The past history information may include columns for timestamps, issue categories, resolution codes, and satisfaction scores. The server maintains indices on user identifiers and temporal fields, so that queries that retrieve context relevant to a current request can be executed with reduced latency. By joining the character information with user state information and past history information, the server can form a compact context representation rather than repeatedly scanning large history tables.

The server employs a task structuring module that converts unstructured character information and retrieved state data into structured information representing the task of the user. In one embodiment, the task structuring module uses a natural language processing pipeline that includes tokenization, part-of-speech tagging, named-entity recognition, and intent classification. The server can implement intent classification by using a neural network classifier, such as a multi-layer perceptron or a transformer encoder, trained on labeled query data. The classifier outputs a normalized task label, such as “product_return,” “network_trouble,” or “security_incident.” The module also extracts entities such as product identifiers, network device types, or route names, and stores them in fields of a task object. The task object may be represented as a record in memory with fields such as task_type, task_text, main_entities, relevant_history_ids, and confidence_score. By constructing this task object, the server obtains a machine-readable and compact representation of the user's problem that is decoupled from raw user text. This structured representation allows the server to reuse prior computation, cache frequent patterns, and ensure that only necessary elements of user state are passed to subsequent modules, thereby improving efficiency and reducing communication overhead to external components such as a generative AI model.

The server uses an emotion analysis module to generate emotion information indicating an emotional state of the user. In one embodiment, the server sends acoustic features derived from the voice data, such as Mel-frequency cepstral coefficients, pitch, energy, and temporal statistics, to an emotion classification network. The network may be a recurrent neural network, a convolutional network, or a transformer-based sequence classifier trained with supervised data where utterances are labeled with emotions such as anger, frustration, neutrality, or satisfaction. In another embodiment, the server applies sentiment analysis to the character information using a text classification model that maps sentences to scores along dimensions such as valence and arousal. In either case, the emotion analysis module produces emotion information including at least one of an emotion label and a numeric intensity score. The server stores the emotion information in association with the user identifier and the task object, for example in an emotion_log table or a memory structure. The server can compare current emotion information with past emotion entries for the same user to compute an emotion trend, such as “increasing frustration” or “decreasing anger.” Because the server uses explicit numeric features and model outputs, the system can programmatically adapt its behavior rather than simply annotating responses for human agents.

The server uses a prompt generation module to construct a prompt sentence for input to a generative AI model. The prompt generation module takes as inputs the task object, the user state information, and the emotion information. The module applies deterministic rules to select which fields to include in the prompt and how to format them. For example, the module may include task_type, relevant entities, a short summary of user history relevant to the task, and a textual description of the emotion state.

The server typically constructs the prompt sentence in a multi-part format that includes (i) an instruction that defines the role of the generative AI model, (ii) a description of the user's query in natural language, (iii) a structured summary of context data, and (iv) explicit constraints on tone and level of detail. Because the prompt sentence follows a consistent template and includes machine-derived task and emotion fields, the generative AI model receives a clear, enriched context that improves response relevance and consistency.

In one concrete example, the server generates a prompt sentence for a product return scenario as follows:
“You are a customer support agent for an online store.
User inquiry: ‘Please tell me how to return a product.’
User's latest order: ‘Wireless headphones, order ID 123456, purchased 5 days ago.’
User emotion: neutral.
Generate a clear, step-by-step explanation of the return procedure for this specific order, including deadlines, required labels, and how to request a pickup. Use polite and concise language.”

In another example, the server generates a prompt sentence for a network trouble scenario with user frustration as follows:
“You are a network support assistant.
User says: ‘The internet is not working.’
User history: in previous incidents, rebooting the home router solved the problem.
User emotion: frustrated.
Generate a polite, empathetic, and reassuring response. Explain step-by-step how to reboot the router and how to check whether the connection is restored. At the end, describe what the user should do if the problem persists.”

In still another example, the server generates a prompt sentence for a vehicle-related question:
“You are an assistant in an autonomous vehicle.
User question: ‘Where is the next stop?’
Current vehicle location: Tokyo Station on the route toward Shinjuku.
Next scheduled stop: Shinjuku.
User emotion: calm.
Generate a short, friendly answer in conversational English that tells the user the name of the next stop.”

The server uses a generative AI interface module to communicate with the generative AI model. The generative AI model may be implemented as a large-scale neural network such as a transformer-based language model with multiple layers, self-attention mechanisms, and learned token embeddings. The model is trained on a large text corpus with a language modeling objective, where the loss function may be a cross-entropy loss between predicted and actual tokens. The model parameters (weights) are updated by stochastic gradient descent or a variant thereof, such as Adam optimization, over many training iterations. The training may also include fine-tuning on domain-specific texts, such as support dialogues or knowledge-base articles, and on prompt-response pairs that involve context and emotional annotations.

The generative AI interface module sends the prompt sentence as a text sequence to the generative AI model via an application programming interface. The module may set generation parameters such as maximum token length, temperature, and top-k or nucleus sampling thresholds. The server receives generated tokens from the model, assembles them into response information, and stores the response information as text. By leveraging a large, pre-trained generative AI model, the server can synthesize detailed and contextually appropriate responses without requiring a hand-written rule set for each domain.

The server then uses a response post-processing module to convert the raw response information into final response information suitable for presentation to the user. The post-processing module may perform operations such as language normalization, insertion of company-specific phrases, segmentation into bullet points, and filtering of undesired content. Crucially, the module can adjust expression style by using the emotion information and user state information. For example, when the emotion information indicates high frustration, the module may prepend an explicit apology, ensure that the text is more concise, and highlight critical steps. When the emotion information indicates calmness and the user state information shows advanced technical skill, the module may include more technical details and optional diagnostics.

The server can implement these adjustments by applying transformation rules or by invoking a secondary lightweight natural language generation function that rewrites parts of the response. Such transformations are deterministic and controlled by numeric thresholds on emotion scores and user profile attributes. This approach differs from simply asking the generative AI model to “be more polite,” because the server retains explicit control over how politeness, detail level, and guidance procedure are altered.

The server uses a communication module to send the final response information to the terminal. The module serializes the final response information as a message, for example in a structured text format, and transmits it over a network channel. The terminal receives the final response information, parses it, and presents it on the display or through the speaker. If desired, the server may convert the final response information to synthetic speech by using a text-to-speech engine that applies neural waveform synthesis methods and then sends audio data to the terminal. In an in-vehicle context, the terminal may also cause the vehicle's onboard interface to show navigation hints or safety messages based on the response.

The described architecture yields technical advantages beyond mere automation of human decision-making. Because the server constructs and uses structured information representing the task and emotion information as internal data structures, the server can perform caching, index-based retrieval, and selective context inclusion. For example, the server can cache pairs of task objects and corresponding generative AI outputs. When a new query arrives with a similar task object and similar user state information, the server can reuse part of the prior response or only request an incremental update from the generative AI model. This reduces the number of calls to the generative AI model and thus reduces network and computation load.

Additionally, the server can analyze statistics over task objects and emotion information distributions to pre-compute typical prompt templates for frequent scenarios. By pre-computing such templates and storing them in a prompt library, the prompt generation module can rapidly construct prompt sentences with fewer string operations, thereby decreasing processing time and memory usage.

The server can also identify, from structured task information, which subset of user state information is actually needed for prompt generation. Instead of blindly attaching the entire user history, the server selects only fields that matter for the given task_type, using a mapping table or a learned attention-like weighting vector. This focused selection reduces the size of prompt sentences, which leads to shorter input sequences to the generative AI model, thereby reducing model execution time and increasing throughput on shared computational resources.

The generative AI model itself operates with a defined architecture, loss function, and training procedure, which provides a reproducible mapping from prompt sentences to output sequences. Training with explicit task and emotion annotations improves the alignment of generated responses with the structured input, reducing variance and error in responses. For example, during fine-tuning, the loss function can be augmented with a penalty term when the generated tone does not match the provided emotion label, causing the model to learn an internal representation that is sensitive to emotion information. As a result, the model more reliably follows instructions about politeness and detail level encoded in the prompt sentence. Alternative embodiments are possible. In one variant, the server integrates the speech recognition engine and emotion analysis engine in a single multi-task neural network that jointly outputs text and emotion scores from acoustic features, sharing lower-layer parameters and thereby reducing total computation. In another variant, the server uses a smaller on-device generative model on the terminal for simple tasks and uses a larger, remote generative AI model for complex tasks. The server can decide which model to use by evaluating the task_type and confidence_score in the task object, thereby balancing latency and quality.

In yet another embodiment, the server is deployed inside a vehicle control system. In this case, the user state information includes real-time sensor data, such as speed, location, and occupancy, and the response information may include actions to adjust human-machine interface parameters. For instance, if the user emotion information indicates high stress, the server may instruct the terminal to reduce non-essential notifications or to change display brightness. Because such actions are triggered by a structured internal representation and deterministic rules, and not merely by free-text heuristics, the system effects a concrete control of a physical device based on computed results.

The described system therefore implements a particular technical arrangement of data structures (task objects, emotion information, prompt sentences), model interfaces, and selection and adjustment logic that improves performance and reliability of a computer system. The server does not merely execute generic steps of receiving data, analyzing data, and displaying results. Instead, the server constructs and exploits machine-readable intermediate representations, uses explicit algorithms to tailor prompt sentences for a generative AI model, and algorithmically adjusts response content and style based on quantified state and emotion information. These features collectively contribute to improved processing efficiency, reduced computational and communication overhead, higher response accuracy, and more stable system behavior, thereby improving the functioning of the computer itself.

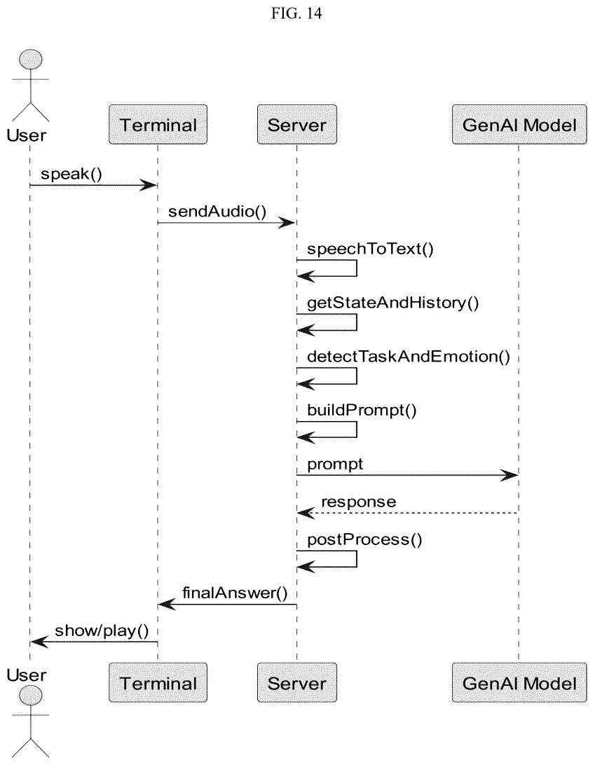

The following describes the processing flow using FIG. 14.

### Step 1

User produces a voice query.
User provides input by speaking into a microphone of the terminal, for example, “Please tell me how to return a product,” “The internet is not working,” or “Where is the next stop?”
User generates an audio signal as output, which is captured by the terminal as an analog sound wave representing the spoken utterance.

### Step 2

Terminal captures and digitizes the voice.
Terminal receives the analog sound wave as input from the microphone and samples it at a predetermined sampling rate (for example, 16 kHz) with a fixed bit depth (for example, 16 bits).
Terminal performs an analog-to-digital conversion to produce digital audio frames as output, for example PCM data, and optionally encodes the PCM data into a compressed format such as Opus or FLAC to reduce size while preserving intelligibility.

### Step 3

Terminal packages audio and metadata and sends them to the server.
Terminal receives as input the encoded audio data and local metadata such as a user identifier, device identifier, language setting, and timestamp.
Terminal constructs a network request (for example, an HTTPS POST request) in which the body contains the encoded audio and the header or payload contains the metadata.
Terminal outputs the request by sending it over a communication network to the server via a network interface, applying encryption and authentication as configured.

### Step 4

Server receives the audio request and stores raw data.
Server accepts as input the incoming network request from the terminal through a web server or API endpoint.
Server validates headers (content type, size limits, authentication token) and extracts the audio payload and metadata.
Server writes the audio payload to a temporary storage location, such as a file path or object key, and stores a reference along with the user identifier and timestamp in a log record.
Server outputs a stored-audio reference and a request context object that includes user ID, audio path, and language.

### Step 5

Server performs speech recognition to obtain character information.
Server receives as input the stored-audio reference and the request context object.
Server loads the audio data and sends it to a speech recognition engine, specifying language and encoding parameters.
Server receives recognition results in a structured format that includes recognized text segments and confidence scores.
Server selects the best hypothesis for each segment and concatenates them into a single text string, producing character information as output, and stores this text in association with the user identifier and request ID.

### Step 6

Server retrieves user state information and past history.
Server uses as input the user identifier from the request context and character information from the speech recognition step.
Server executes database queries on an information storage device to retrieve user state information (for example, account status, service plan, device type) and past history information (for example, past inquiries, transactions, resolutions) relevant to the user.
Server may filter and sort records by recency or category, and outputs a context data structure that includes selected user state fields and a subset of relevant history records.

### Step 7

Server generates a structured task representation.
Server receives as input the character information and the context data structure comprising user state information and past history information.
Server applies natural language processing operations to the character information, including tokenization, intent classification, and entity extraction, and correlates extracted entities with entries in the user state and history (for example, linking a mentioned product name to a specific order record).
Server determines a task type (for example, “product_return,” “network_trouble,” “security_incident,” or “next_stop”) and populates a task object with fields such as task_type, task_text (the raw text), main_entities (for example, order ID, route name), and relevant_history_ids.
Server outputs this task object as structured information representing the task.

### Step 8

Server performs emotion analysis.
Server receives as input at least one of the voice data (from the stored-audio reference) and the character information.
Server extracts acoustic features from the voice data, such as pitch, energy, and spectral coefficients, or token-based features from the character information, and feeds these features to an emotion classification model.
Server computes an emotion label (for example, “neutral,” “frustrated,” “angry,” “calm”) and an intensity score based on the model's output probabilities.
Server stores the emotion label and intensity in association with the task object and outputs an emotion information object including fields such as current_emotion and intensity_score.

### Step 9

Server integrates task, context, and emotion into a unified situation representation.
Server uses as input the task object, the context data structure, and the emotion information object.
Server merges these inputs into a situation object by attaching user state attributes (for example, service tier, prior similar issues) and emotion attributes to the task fields.
Server may compute a priority flag or escalation indicator by applying rules that combine task_type, relevant_history_ids, and current_emotion (for example, repeated “delivery_delay” with “angry” emotion yields a high-priority flag).
Server outputs the situation object as a comprehensive representation of the current interaction.

### Step 10

Server constructs a prompt sentence for the generative AI model.
Server receives as input the situation object that includes the task, user state, and emotion.
Server applies deterministic formatting rules to select and arrange information for inclusion in a prompt, such as (i) a role description for the generative AI model, (ii) the user's query quotation, (iii) a short summary of relevant history and context, and (iv) a description of the user's emotional state and required tone, level of detail, and guidance procedure.
Server concatenates these elements into a single text sequence, ensuring that key fields (task_type, entities, emotion label) are clearly identified.
Server outputs this text sequence as a prompt sentence ready to be sent to the generative AI model.

### Step 11

Server sends the prompt sentence to the generative AI model and obtains response information.
Server uses as input the prompt sentence and generation parameters such as maximum length and randomness setting.
Server transmits the prompt sentence to a generative AI model via a model interface, which may be implemented as an API call to a transformer-based language model.
Server receives as output a sequence of tokens from the generative AI model, assembles them into readable text, and stores this text as response information associated with the situation object.

### Step 12

Server post-processes the response information into final response information.
Server accepts as input the raw response information from the generative AI model, the emotion information, and the user state information.
Server analyzes the response text to adjust structure (for example, splitting long paragraphs into steps), and applies rules that modify expression style based on emotion (for example, add explicit apologies for “angry” emotion, or add more detailed explanations for novice users as indicated by user state).
Server may insert context-specific data (for example, precise order IDs, links, or next-stop names) into designated placeholders in the response text.
Server outputs final response information that conforms to a predetermined writing style and guidance structure suitable for presentation to the user.

### Step 13

Server transmits the final response information to the terminal.
Server uses as input the final response information and the terminal address or session identifier.
Server encapsulates the final response information in a response message and sends it over the network to the terminal using a communication protocol such as HTTPS or a persistent messaging channel.
Server outputs a transmission result indicating successful delivery or error status and may log the exchange for future analysis.

### Step 14

Terminal presents the final response to the user.
Terminal receives as input the response message containing the final response information.
Terminal parses the message, extracts the response text, and renders it on a display in a user interface, for example as a chat bubble or a step-by-step instruction list.
Terminal optionally uses a local or remote text-to-speech engine to convert the response text to audio and plays it through a speaker.
Terminal outputs the presented information as a visual and/or auditory response that the user can perceive and act upon.

### Step 15

User consumes the response and may initiate a follow-up query.
User receives as input the displayed or spoken final response information from the terminal.
User interprets the instructions, performs suggested actions such as rebooting a device, requesting a return, or confirming the next stop, and evaluates whether the problem is resolved.
User outputs a new voice query, if necessary, by speaking again into the terminal, thereby providing new voice data that restarts the processing flow from Step 1 with updated state and emotion context.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

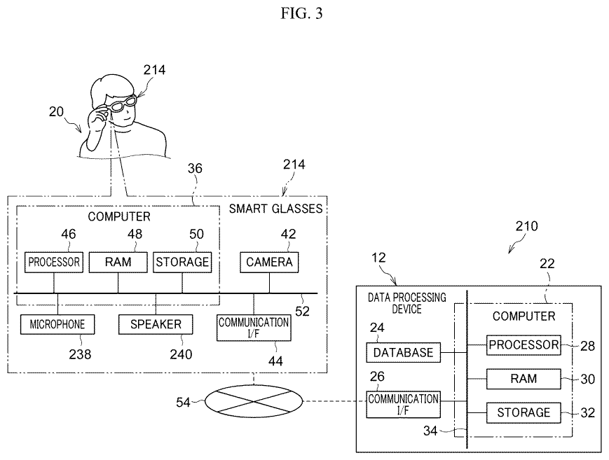

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

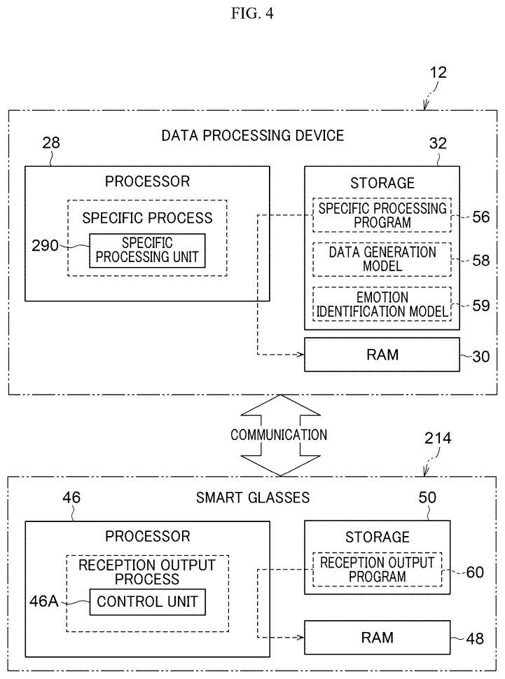

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

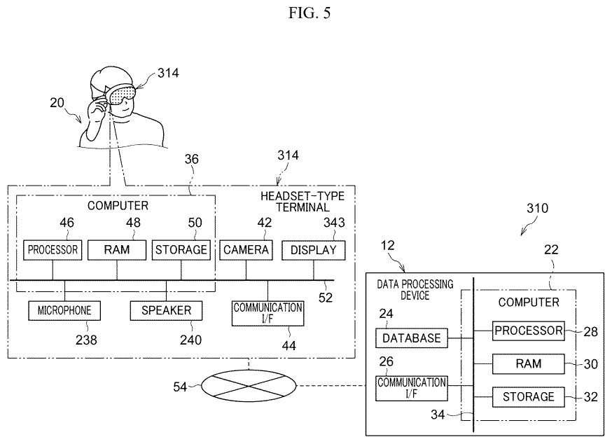

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

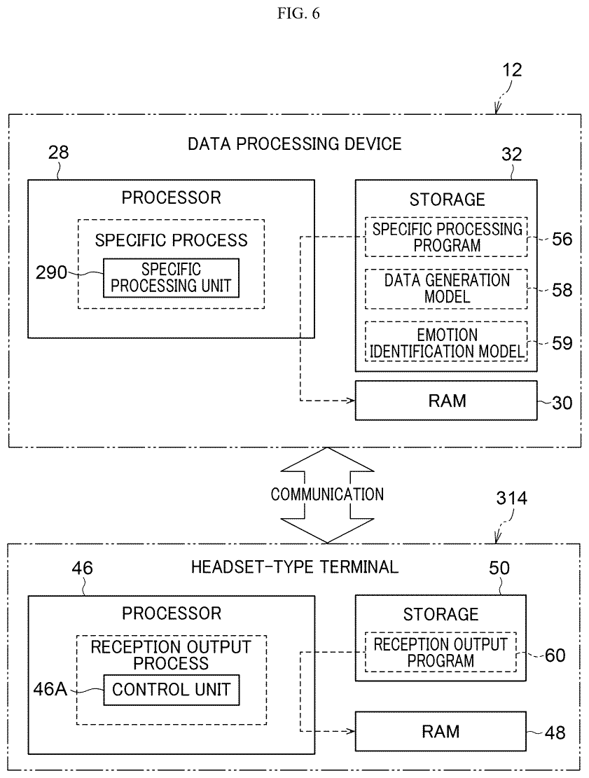

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

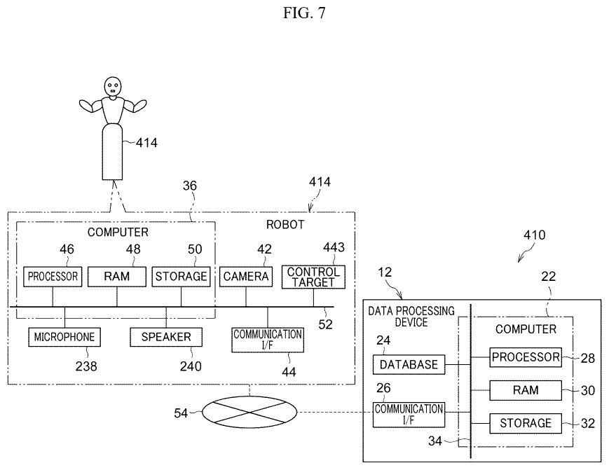

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

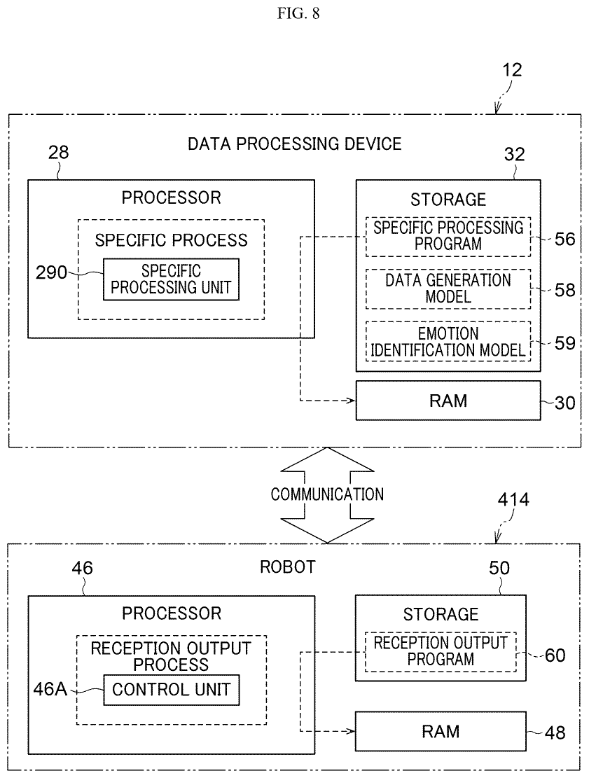

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

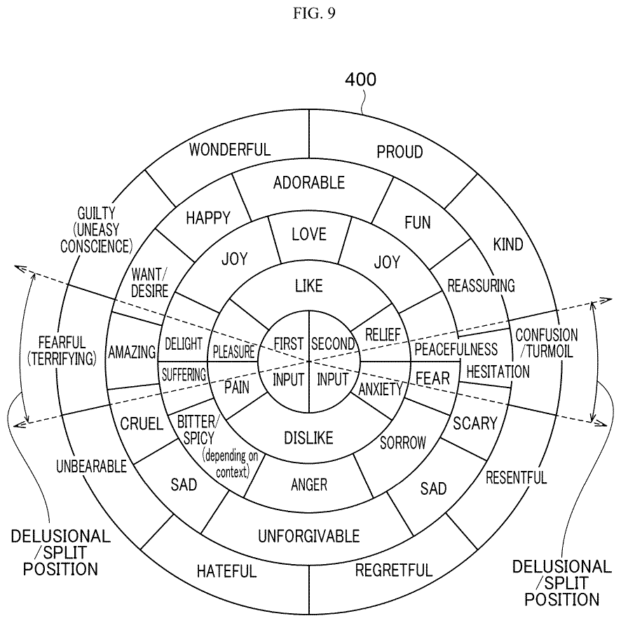

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

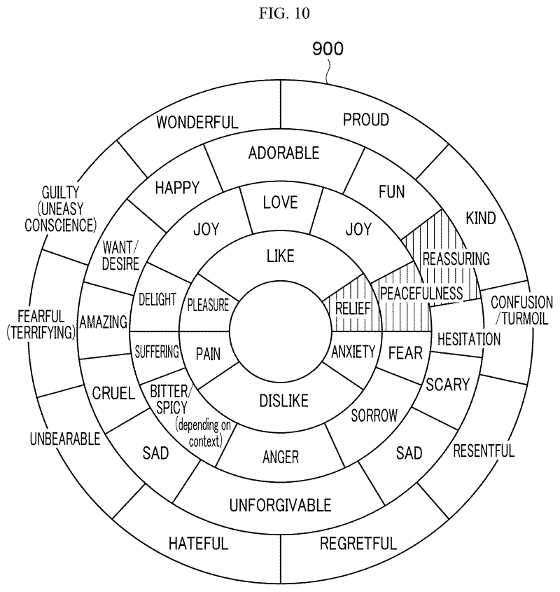

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive voice data of a user as input information from a terminal, analyze the received voice data by using a speech recognition process including an acoustic model and a language model to generate character information representing a recognition result of the voice data,
acquire, from an information storage device, history information related to the user based on user identification information, and combine and analyze the character information and the history information to extract specific information relating to a task of the user, construct a prompt sentence for input to a generative AI model based on the specific information and the history information, the prompt sentence including a type of the task and related target information, input the prompt sentence to the generative AI model, and cause the generative AI model to execute a text generation process to generate solution information for the task, and
format the solution information output from the generative AI model into a predetermined display format, and transmit the formatted solution information to the terminal to provide the solution information to the user.

### Supplementary 2

The system according to supplementary 1,
wherein the processor is configured to use a natural language processing technique to extract intent information and target information from the character information, to compare the intent information and the target information with the history information to identify a most relevant target for the user, and to include a result of the identification in the prompt sentence.

### Supplementary 3

The system according to supplementary 1,
wherein the processor is configured to select a template predefined for each type of the task, and to generate the prompt sentence by allocating the character information, the history information, and the specific information to predetermined positions in the selected template.

### Application Example 1

### Supplementary 1

A system comprising a processor,
wherein the processor is configured to
acquire voice input of a user, analyze an audio signal from the voice input by using a speech processing function, and convert the audio signal into character information,
obtain user state information from a storage device based on user identification information associated with the character information, and extract preference information of the user based on purchase history information and browsing history information included in the user state information,
analyze the character information and the preference information to specify an intention of the user and a task of the user, and generate context information including an intention type, a target item, a budget range, and preference attributes,
generate a prompt sentence including the context information and the character information, and input the prompt sentence into a generative AI model including a natural language processing function, to instruct the generative AI model to generate response information including a solution for the task of the user and proposal information of a target item suitable for the user,
extract identification information of a target item from the response information, obtain attribute information of the target item from a product information storage device based on the identification information, and generate presentation information by associating explanation information included in the response information with the attribute information, and
transmit the presentation information to a user terminal and control that the user terminal presents the target item and presents the solution.

### Supplementary 2

The system according to supplementary 1,
wherein the processor is configured to
obtain inventory status information and price information from the product information storage device based on the identification information of the target item included in the response information, generate list information of the target item including the inventory status information and the price information as the presentation information, store operation information indicating a selection operation of the user on the list information as log information, and update control content of generation processing of the context information or generation processing of the prompt sentence based on the log information.

### Supplementary 3

The system according to supplementary 1,
wherein the processor is configured to
analyze emotion information by using an emotion analysis function for the voice input of the user, include the emotion information in the context information, and include instruction content reflecting the emotion information in the prompt sentence, thereby controlling an expression format of the solution and the proposal information of the target item generated by the generative AI model.

### Example 2

### Supplementary 1

A system comprising a processor,
wherein the processor is configured to
acquire inquiry information from a user as audio information or character information, and receive the acquired inquiry information together with an identifier via a communication path,
analyze the inquiry information when the received inquiry information includes the audio information by using a voice processing function, convert the audio information into character information, and store the converted character information as inquiry character information,
perform structuring processing on the inquiry character information or on character information input by the user by using a natural language processing function, and generate analysis result data by extracting intent information and element information,
acquire user state information from an information management apparatus based on user identification information, combine the user state information with the analysis result data to generate task context data, and specify a user task based on the task context data,
generate prompt data by constructing a prompt sentence to be input to a generative AI model using the task context data as an input value and based on template information and rule information, and record the prompt data, vvsend the prompt data to the generative AI model via a communication interface, and acquire response information generated by the generative AI model based on the prompt sentence as solution information, and
perform format conversion processing or content checking processing on the solution information to generate output solution information according to a provision form to the user, and send the output solution information to a user terminal or a support personnel terminal to provide the output solution information to the user.

### Supplementary 2

The system according to supplementary 1,
wherein the processor is configured to
perform emotion analysis processing on the audio information or the character information included in the inquiry information when generating the analysis result data, extract emotion information, include the emotion information in the task context data, and reflect the emotion information in the prompt sentence.

### Supplementary 3

The system according to supplementary 1,
wherein the processor is configured to
convert the output solution information into a text format or a voice synthesis data format, and send converted information to the user terminal so that the converted information is displayed or output as voice.

### Application Example 2

### Supplementary 1

A system comprising a processor,
wherein the processor is configured to
acquire voice data of a user from a terminal device and analyze a voice signal included in the voice data by using a speech recognition technique so as to convert the voice signal into character information,
acquire user state information and past history information from an information storage device on the basis of identification information of the user, integrate the character information with the user state information and the past history information to specify a task of the user, and generate structured information representing the task,
generate a prompt sentence for input to a generative AI model on the basis of the structured information representing the task and the user state information, and cause the generative AI model to generate response information including a solution for the task by inputting the prompt sentence to the generative AI model,
perform post-processing on the response information in accordance with a predetermined format or expression style to generate final response information for presentation to the user, and
transmit the final response information to the terminal device so that the final response information is provided to the user via the terminal device.

### Supplementary 2

The system according to supplementary 1,
wherein the processor is configured to
apply an emotion analysis technique to at least one of the voice data and the character information to generate emotion information indicating an emotional state of the user, and embed the emotion information into the prompt sentence together with the structured information representing the task so as to instruct the generative AI model to generate a response corresponding to the emotional state of the user.

### Supplementary 3

The system according to supplementary 1,
wherein the processor is configured to
adjust at least one of content and expression style of the prompt sentence and the response information on the basis of the emotion information and the user state information, and generate the final response information in which at least one of politeness, level of detail, and guidance procedure is changed in accordance with the emotional state of the user.

What is claimed is:

1. A system comprising:
circuitry configured to:
receive, via a communication interface coupled to a packet-switched network, voice data from a terminal device, and analyze the voice data by using a speech recognition process including an acoustic model and a language model to generate character information representing a transcription of a user utterance;
apply a natural language processing program to the character information to extract intent information specifying a task type and target information specifying one or more candidate entities associated with the task;
retrieve, from a storage device, history information associated with the user based on user identification information, the history information including at least purchase history information and browsing history information;
compare the intent information and the target information with the history information by computing similarity scores and apply matching rules to select a most relevant history record, and construct specific information including the task type, a selected target entity, and contextual attributes derived from the selected history record;
select a prompt template corresponding to the task type from a set of predefined prompt templates, and construct a prompt sentence by inserting the character information, the history information, and the specific information into placeholder positions in the selected prompt template;
transmit the prompt sentence to a generative neural network model and receive solution information generated by the generative neural network model in response to the prompt sentence; and
apply format conversion processing to the solution information to generate output solution information, and transmit the output solution information to the terminal device via the communication interface.

2. The system according to claim 1, wherein the circuitry is configured to perform emotion analysis on the voice data to generate emotion information indicating an emotional state of the user, and incorporate the emotion information into the specific information and into the prompt sentence such that the generative neural network model adjusts a content and tone of the solution information based on the emotional state.

3. The system according to claim 2, wherein the circuitry is configured to update the prompt sentence based on the emotion information by selecting a prompt template variant associated with the detected emotional state from among a plurality of predefined template variants.

4. The system according to claim 3, wherein the circuitry is configured to record prompt data generated from the prompt sentence in a storage device indexed by a session identifier and a timestamp for auditability, and use the recorded prompt data to enable later re-evaluation of the prompt construction process.

5. The system according to claim 4, wherein the circuitry is configured to apply content checking processing to the solution information received from the generative neural network model to validate that the solution information satisfies predefined output constraints before generating the output solution information.

6. The system according to claim 1, wherein the circuitry is configured to extract identification information of a target item from the solution information, retrieve attribute information of the target item from a product information storage device based on the identification information, and generate presentation information by associating explanation information included in the solution information with the attribute information.

7. The system according to claim 6, wherein the circuitry is configured to retrieve inventory status information and price information from the product information storage device based on the identification information of the target item, and include the inventory status information and price information in the presentation information transmitted to the terminal device.

8. The system according to claim 7, wherein the circuitry is configured to extract preference information of the user based on purchase history information and browsing history information included in the history information, and generate context information including an intention type, a target item identifier, a budget range, and preference attributes derived from the preference information.

9. The system according to claim 8, wherein the circuitry is configured to construct the prompt sentence by including the context information and the character information, and instruct the generative neural network model to generate response information including a solution for the task and proposal information identifying a target item suitable for the user.

10. The system according to claim 1, wherein the circuitry is configured to receive inquiry information as audio information or character information via the communication interface, and when the inquiry information is received as audio information, apply a voice processing function to the audio information to generate inquiry character information prior to applying the natural language processing program.

11. The system according to claim 10, wherein the circuitry is configured to execute natural language processing on the inquiry character information to generate analysis result data including intent information and element information, and combine the analysis result data with user state information retrieved from an information management apparatus to generate task context data specifying the user task.

12. The system according to claim 11, wherein the circuitry is configured to construct the prompt sentence based on the task context data and on template information and rule information, such that the prompt sentence incorporates rule-constrained formatting alongside the task context data.

13. The system according to claim 12, wherein the circuitry is configured to transmit the output solution information to at least one of the terminal device associated with the user and a support personnel terminal, and apply routing logic based on the task type to determine which terminal receives the output solution information.

14. The system according to claim 1, wherein the circuitry is configured to normalize the character information by applying tokenization and standardization operations, and generate a sequence of tokens and corresponding numerical representations suitable for application of the natural language processing program.

15. The system according to claim 14, wherein the circuitry is configured to apply a transformer-based text encoder to the character information to generate an embedding vector, and compute similarity between the embedding vector and reference answer embeddings associated with respective task types to determine the task type with highest relevance.

16. The system according to claim 1, wherein the circuitry is configured to store the solution information and associated session metadata in a storage device indexed by user identification information and session identifier, and provide the stored records for model retraining using the stored session data as training examples.

17. The system according to claim 16, wherein the circuitry is configured to acquire voice data from a wearable terminal device, perform the speech recognition process on the voice data in near real time, and provide the output solution information to the wearable terminal device for presentation via an audio output device of the wearable terminal device.

18. A system comprising:
circuitry configured to:
receive, via a communication interface coupled to a packet-switched network, voice data from a terminal device, and analyze the voice data by using a speech recognition process including an acoustic model and a language model to generate character information;
apply a natural language processing program to the character information to extract intent information and target information, retrieve history information from a storage device based on user identification information, and compare the intent information and target information with the history information to construct specific information including a task type, a selected target entity, and contextual attributes;
select a prompt template corresponding to the task type and construct a prompt sentence by inserting the character information, the history information, and the specific information into placeholder positions in the selected prompt template;
transmit the prompt sentence to a generative neural network model and receive solution information generated by the generative neural network model;
perform emotion analysis on the voice data to generate emotion information, and incorporate the emotion information into the prompt sentence such that the generative neural network model adjusts a tone and content of the solution information based on the emotion information; and
apply format conversion processing to the solution information and transmit output solution information to the terminal device via the communication interface.

19. The system according to claim 18, wherein the circuitry is configured to extract identification information of a target item from the solution information, retrieve attribute information including inventory status and price information from a product information storage device based on the identification information, and generate presentation information associating explanation information from the solution information with the attribute information.

20. A method comprising:
receiving, via a communication interface coupled to a packet-switched network, voice data from a terminal device, and analyzing the voice data by using a speech recognition process including an acoustic model and a language model to generate character information representing a transcription of a user utterance;
applying a natural language processing program to the character information to extract intent information specifying a task type and target information specifying one or more candidate entities associated with the task;
retrieving, from a storage device, history information associated with the user based on user identification information, the history information including at least purchase history information and browsing history information;
comparing the intent information and the target information with the history information by computing similarity scores and applying matching rules to select a most relevant history record, and constructing specific information including the task type, a selected target entity, and contextual attributes derived from the selected history record;
selecting a prompt template corresponding to the task type from a set of predefined prompt templates, and constructing a prompt sentence by inserting the character information, the history information, and the specific information into placeholder positions in the selected prompt template;
transmitting the prompt sentence to a generative neural network model and receiving solution information generated by the generative neural network model in response to the prompt sentence; and
applying format conversion processing to the solution information to generate output solution information, and transmitting the output solution information to the terminal device via the communication interface.
